(19) United States
(12) Patent Application Publication
(10) Pub. No.: US 2020/0387543 A1
(43) Pub. Date: Dec. 10, 2020

(54) TRADEMARK INQUIRY RESULT PROXIMITY EVALUATING AND SORTING METHOD AND DEVICE

(71) Applicants: Qing Xu, Foshan (CN); Foshan Guofang Trademark Service Co., Ltd., Foshan (CN); Foshan Guofang Trademark Identification Technology Co., Ltd., Foshan (CN)

(72) Inventor: Qing XU, Foshan (CN)

(73) Assignees: Foshan Guofang Trademark Service Co., Ltd., Foshan (CN); Foshan Guofang Trademark Identification Technology Co., Ltd., Foshan (CN)

(21) Appl. No.: 16/475,333

(22) PCT Filed: Sep. 1, 2017
(86) PCT No.: PCT/CN2017/100187

§ 371 Date: Jul. 1, 2019

(30) Foreign Application Priority Data
Dec. 30, 2016 (CN) 201611257312.6
Jul. 7, 2017 (CN) 201710553009.9

(51) Int. Cl. G06F 16/906; G06F 16/903; G06K 9/62

(52) U.S. Cl. CPC G06F 16/906; G06Q 50/184; G06K 9/6215; G06F 16/90335

(57) ABSTRACT

The present invention discloses a method and a device for evaluating and sorting of trademark query results similarities. The method comprises: performing scorecard processing on sample trademarks and input trademarks from different perspectives like shape, sound and meaning, so as to respectively acquire shape, sound and meaning scorecard information of the sample trademark and the input trademarks; acquiring matching information between the resultant trademarks and the input trademarks by retrieving, and then calculating a shape similarity, a trademark meaning similarity, a trademark sound similarity and a scoring rate of retrieval keywork matching between the resultant trademarks and the input trademarks according to preset formulas, thereby acquiring comprehensive quantified values of trademark similarities by calculation, and sorting the resultant trademarks according to magnitudes of the comprehensive quantified values of trademark similarities.

### TECHNICAL FIELD

The present invention relates to the field of trademark information retrieving, and more particularly, to a method and device for evaluating and sorting similarities of trademark query results.

### BACKGROUND

Trademark query is of great significance to trademark registration, management and protection. The functions of the trademark query are reflected in finding obstacles to trademark registration and application in time, finding out whether the trademarks can be used safely, finding out the trademarks rushly registered by others, knowing the legal status of the trademarks, and finding out the detailed information of the right scope of the relevant trademarks. However, the resultant trademarks reported by the current trademark query system have the following defects and drawbacks.

There are many kinds of feature values of the resultant trademarks reported by the traditional trademark query system, such as: a Chinese name feature of the trademark, an English name feature of the trademark, a syllable letter feature, a graph element coding feature, an image feature descriptor, and the like. However, none of the feature values can fully reflect a comprehensive feature of a combination of shape, sound and meaning of the trademark, thus possibly causing trademark sameness or similarity to be judged incorrectly.

2. The resultant trademarks of the traditional trademark query system are usually sorted according to a single feature therein, but two or more features cannot be sorted in parallel. Therefore, the sorted resultant trademarks reported and displayed by the traditional trademark query system have certain one-sidedness.

3. The traditional trademark query system requires continuous interaction with retrieval users. The ranking results are not fixed or do not have consistency of trademark sameness or similarity judgment standards. Therefore, the trademark similarity sorting described by the traditional method is quite different from the trademark sameness or similarity in the sense of the Trademark Law.

For example, the Chinese invention patent with an application number of 201410043915.0 is titled trademark query system and method, wherein the trademark query system comprises: a query module, configured to receive a trademark to be queried; a feature extraction module, configured to extract a trademark feature of the trademark to be queried; an index library, configured to store the extracted trademark feature of the trademark to be queried; a trademark library, configured to store existing trademarks; a feature library, configured to store the trademark feature of the existing trademark; a retrieving module, configured to match the trademark feature of the trademark to be queried with the trademark feature of the existing trademark; and a display module, configured to display the matching results. By extracting the trademark feature of the trademark to be queried, matching the extracted trademark feature with the trademark features of the existing trademarks stored in the feature library, and displaying the matching results, the workload of examiners is reduced and the working efficiency is improved.

Paragraph 0043 of the description of the patent discloses the existing calculation method or realization method for a trademark similarity: a retrieving module 106 is mainly configured to realize a retrieving and matching process, realize trademark matching and screening according to a correlation calculation method, and finally feed-back the acquired results meeting the requirement to the user. The retrieval module 106 provides a retrieval interface to the user based on content query, and converts a retrieval request of the user into a question that can operate a database. The retrieval is allowed to be performed direct at global objects, such as the entire trademark, as well as sub-objects and any combination thereof. The results returned by the retrieving module 106 can be arranged and outputted according to the similarity, the display module 107 can display the existing trademarks sorted, and further query can be performed based on the acquired retrieval results if it is necessary. Because the retrieval based on the content realizes the similarity retrieval, which is consisting of imitating a cognitive process of human, the retrieval results need to be further refined through continuous interaction with the retrieval users.

The technical solution of the patent above can only solve the problem of respectively sorting the matched similarities of single or one-by-one retrieval request of the user, but cannot solve the problem of comprehensively sorting the similarities capable of matching a plurality of retrieval requests generated by the plurality of retrieval requests. Since any single feature of the existing trademark cannot comprehensively reflect the comprehensive features of the combination of shape, sound and meaning of the trademark, the sorting results of similarities according to the single feature may not necessarily meet the requirement for the trademark sameness and similarity in the sense of the Trademark Law, and the acquired sorting results of similarities may possibly cause the user of the trademark query system to incorrectly think that the trademarks sorted in the top may have the trademark sameness and similarity in the sense of the Trademark Law, which may possibly lead to serious mistakes in trademark registration, management and protection. On the other hand, according to the existing trademark query method, the sorting of the trademark similarity further needs to be continuously interacted with the user of the trademark query system to provide the sorting results of a variety of different feature matching similarities for reference of the user, which also increases the query workload of the user.

### SUMMARY

In view of this, the object of the present invention is to provide a method and device for evaluating and sorting similarities of trademark query results, which can acquire comprehensive quantified values of trademark similarity that comprehensively evaluate the retrieved resultant trademarks and the input trademarks in terms of multiple features, and sort the resultant trademarks according to the magnitudes of the comprehensive quantified values, so that the resultant trademarks seen by the user more conform to the requirements of the trademark sameness or similarity in the sense of the Trademark Law, and avoid defects such as omission and misstatement of trademark retrieval caused by the fact that the single feature sorting cannot comprehensively reflect the multiple features of the trademarks.

In order to achieve the above object, the technical solution adopted by the present invention is as follows.

A method for evaluating and sorting similarities of trademark query results performs similarity evaluating and sorting processing on similar trademark query results, comprises the following steps:

step S110: performing trademark scorecard processing on sample trademark images and contents according to preset trademark scorecard standards, wherein a specific processing procedure comprises: (1) establishing a trademark scorecard standard consisting of preset multiple combination schemes of shape feature minimum units, preset multiple combination schemes of sound feature minimum units, and preset multiple combination schemes of meaning feature minimum units, (2) identifying whether the sample trademarks contain elements of Chinese characters, graphs, letters, numerals or symbols, and acquiring contents of the elements, (3) extracting a shape feature minimum unit, a sound feature minimum unit and a meaning feature minimum unit of each element of the sample trademarks, and (4) according to the established trademark scorecard standard, extracting segmentation information of various characters and graphs generated or converted by each combination scheme, using the segmentation information as the sample trademark scorecard information, and setting a similarity evaluation score for each preset trademark scorecard standard;

step S120: performing trademark scorecard processing on input trademark images and contents according to preset trademark scorecard standards, wherein a specific processing procedure comprises: (1) establishing a trademark scorecard standard consisting of preset multiple combination schemes of shape feature minimum units, preset multiple combination schemes of sound feature minimum units, and preset multiple combination schemes of meaning feature minimum units, (2) identifying whether the input trademarks contain elements of Chinese characters, graphs, letters, numerals or symbols, and acquiring contents of the elements, (3) extracting a shape feature minimum unit, a sound feature minimum unit and a meaning feature minimum unit of each element of the input trademarks, and (4) according to the established trademark scorecard standard, extracting segmentation information of various characters and graphs generated or converted by each combination scheme, and using the segmentation information as input trademark scorecard information;

step S130: retrieving the sample trademark scorecard information stored in a trademark storage by using an input trademark scorecard information set as a retrieval keywork, and acquiring scorecard information and scorecard matching information of relevant resultant trademarks;

step S140: according to preset calculation formulas for a trademark shape similarity, a trademark meaning similarity, a trademark sound similarity and a scoring rate of retrieval keywork matching, respectively calculating a trademark shape similarity, a trademark meaning similarity, a trademark sound similarity and a scoring rate of retrieval keywork matching between the input trademarks and the resultant trademarks; and

step S150: according to a preset calculation formula for comprehensive quantified values of trademark similarity, acquiring comprehensive quantified values of trademark similarity by calculation, and sorting the resultant trademarks according to magnitudes of the comprehensive quantified values of trademark similarity.

The “shape feature minimum units, the sound feature minimum units, the meaning feature minimum units” and the “trademark scorecard standard” described in the steps S110 and S120 of the method for evaluating and sorting similarities of trademark query results, comprise:

1) the shape feature minimum units comprising:

a shape feature minimum unit the elements of which are Chinese characters, and selected from one of the followings: each Chinese character, and each stroke of each Chinese character;

a shape feature minimum unit the elements of which are graphs, and selected from one of the followings: a trademark graph element code, and a pixel set with a preset length on a trademark image contour line;

a shape feature minimum unit the elements of which are letters, and selected from one of the followings: words in each language, and each letter;

a shape feature minimum unit the elements of which are Chinese numerals, and selected from one of the followings: a combination of Chinese numerals, and each single Chinese numeral;

a shape feature minimum unit the elements of which are Arabic numerals, and selected from one of the followings: a combination of Arabic numerals, and each single Arabic numeral;

a shape feature minimum unit the elements of which are numerals in other languages, and selected from one of the followings: a combination of numerals in other languages, and each single numeral in other languages; and

a shape feature minimum unit the elements of which are symbols: each signal symbol;

2) the meaning feature minimum units comprising:

a meaning feature minimum unit the elements of which are Chinese characters: when an overall combination of Chinese characters of a trademark is composed of a combination of vocabularies recorded in a Chinese dictionary, each vocabulary is the meaning feature minimum unit; otherwise, the overall combination of Chinese characters of the trademark is the meaning feature minimum unit;

a meaning feature minimum unit the elements of which are graphs: a name of each thing corresponding to the trademark graph element code;

a meaning feature minimum unit the elements of which are letters: when an overall combination of letters of the trademark is composed of a combination of words recorded in an English dictionary, or a combination of words recorded in a dictionary in other languages, each word is the meaning feature minimum unit; otherwise, the overall letter combination of the trademark is the meaning feature minimum unit;

a meaning feature minimum units the elements of which are Chinese numerals, and selected from one of the followings: numerals in a preset reference language corresponding to each group of Chinese numerals separated in the trademark, and numerals in a preset reference language corresponding to each single Chinese numeral in the trademark, wherein the numerals in the preset reference language are numerals in any languages;

a meaning feature minimum units the elements of which are Arabic numerals, and selected from one of the followings: numerals in a preset reference language corresponding to each group of Arabic numerals separated in the trademark, and numerals in a preset reference language corresponding to each single Arabic numeral in the trademark, wherein the numerals in the preset reference language are numerals in any languages;

a meaning feature minimum units the elements of which are numerals in other languages, and selected from one of the followings: numerals in a preset reference language corresponding to each group of numeral in other languages separated in the trademark, and numerals in a preset reference language corresponding to each single numeral in other languages in the trademark, wherein the numerals in the preset reference language are numerals in any languages; and

a meaning feature minimum units the elements of which are symbols: a symbolic name corresponding to each symbol in the trademark;

3) the sound feature minimum units comprising:

a sound feature minimum units the elements of which are Chinese characters: Pinyin of each Chinese character;

a sound feature minimum unit the elements of which are graphs: Pinyin of a name of each thing corresponding to the trademark graph element code;

a sound feature minimum units the elements of which are letters, and selected from one of the followings: a sound of each combination of letters, and a sound of each letter; and

a sound feature minimum units the elements of which are numerals or symbols, and selected from one of the followings: a sound of each group of numerals separated in the trademark, a sound of each single numeral, a sound of each group of symbols separated in the trademark, and a sound of each single symbol; and

4) the trademark scorecard standard comprising:

A. a trademark scorecard standard consisting of multiple combination schemes of the shape feature minimum units the elements of which are Chinese characters, comprising: at least one of scorecard standards a₁, a₂, a₃, a₄, a₅, a₆, a₇, as, a₉, a₁₀, a₁₁, a₁₂ and a₁₃, wherein:

a₁ indicates that an overall combination of characters in all languages and graph element codes of the trademark arranged in order is segmented into one scorecard,

a₂ indicates that an overall combination of characters in all languages and graph element codes of the trademark arranged in a reversed order is segmented into one scorecard,

a₃ indicates that Chinese characters in the trademark arranged in order are segmented into one scorecard,

a₄ indicates that Chinese characters in the trademark arranged in a reversed order are segmented into one scorecard,

a₅ indicates that Chinese numerals in the trademark arranged in order are segmented into one scorecard,

a₆ indicates that Chinese numerals in the trademark arranged in a reversed order are segmented into one scorecard,

a₇ indicates that each relatively independent part in the trademark is segmented into one scorecard respectively,

a₈ indicates that the characters in the trademark completely contain the existing trademark in Chinese characters, and the part is segmented into one scorecard,

a₉ indicates that traditional and variant Chinese characters contained in the trademark are converted into simplified Chinese characters and then segmented into one scorecard,

a₁₀ indicates that each character in the trademark after being replaced by a shape-approximate character is segmented into one scorecard,

a₁₁ indicates that every adjacent Chinese characters in the trademark are segmented into one scorecard respectively,

a₁₂ indicates that a combination of first and last Chinese characters in the trademark is segmented into one scorecard, and

a₁₃ indicates that each Chinese character in the trademark is segmented into one scorecard;

B. a trademark scorecard standard consisting of multiple combination schemes of the shape feature minimum units the elements of which are letters, numerals and symbols, comprising: at least one of scorecard standards b₁, b₂, b₃, b₄, b₅, b₆, b₇, b₈, b₉, b₁₀, b₁₁, b₁₂, b₁₃ and b₁₄, wherein:

b₁ indicates that an overall combination of characters in all languages and graph element codes of the trademark arranged in order is segmented into one scorecard,

b₂ indicates that the overall combination of characters in all languages and graph element codes of the trademark arranged in a reversed order is segmented into one scorecard,

b₃ indicates that a combination of letters in the trademark arranged in order is segmented into one scorecard,

b₄ indicates that a combination of letters in the trademark arranged in a reversed order is segmented into one scorecard,

b₅ indicates that non-Chinese numerals contained in the trademark arranged in order or each single non-Chinese numeral is segmented into one scorecard respectively.

b₆ indicates that non-Chinese numerals contained in the trademark arranged in a reversed order or each single non-Chinese numeral is segmented into one scorecard respectively,

b₇ indicates that a combination of symbols contained in the trademark arranged in order is segmented into one scorecard,

b₈ indicates that a combination of symbols contained in the trademark arranged in a reversed order is segmented into one scorecard,

b₉ indicates that each relatively independent part in the trademark is segmented into one scorecard respectively,

b₁₀ indicates that each letter in the trademark after being replaced by a shape-approximate letter is segmented into one scorecard,

b₁₁ indicates that a combination of every adjacent letters in the trademark is segmented into one scorecard respectively,

b₁₂ indicates that letters in the trademark are arranged in different orders, and then segmented into one scorecard respectively,

b₁₃ indicates that a combination of first and last letters in the trademark is segmented into one scorecard, and

b₁₄ indicates that each letter, or numeral, or symbol in the trademark is segmented into one scorecard respectively;

C. a trademark scorecard standard consisting of multiple combination schemes of the shape feature minimum units the elements of which are graphs, comprising: at least one of scorecard standards c₁, c₂, c₃ and c₄, wherein:

c₁ indicates that a trademark graph element code set is entirely segmented into one scorecard,

c₂ indicates that each trademark graph element code is segmented into one scorecard,

c₃ indicates that an entirety of trademark image feature descriptors generated by each image feature recognition method is segmented into one scorecard respectively,

c₄ indicates that a preset length of the trademark image feature descriptor generated by each image feature recognition method is segmented into one scorecard respectively, and the preset length of the trademark image feature descriptor refers to a preset length of consecutively connected pixels on a trademark image contour line, the consecutively connected pixels are represented by a feature character string set or a numeral set, and a value ranges from 0.1% to 50% of an overall length of the trademark image feature descriptor or the numeral set;

D. a trademark scorecard standard consisting of multiple combination schemes of the sound feature minimum units the elements of which are Chinese characters, comprising: at least one of scorecard standards d₁, d₂ and d₃, wherein:

d₁ indicates that a Pinyin syllable of each Chinese character in the trademark is segmented into one scorecard,

d₂ indicates that Pinyin syllables corresponding to the overall Chinese characters in the trademark are segmented into one scorecard, and

d₃ indicates that the Pinyin syllable of each Chinese character in the trademark after being replaced by a shape-approximate character is segmented into one scorecard,

E. a trademark scorecard standard consisting of multiple combination schemes of the sound feature minimum units the elements of which are letters, numerals and symbols, comprising: at least one of scorecard standards e₁, e₂, e₃ and e₄, wherein:

e₁ indicates that a sound syllable of each English word in the trademark is segmented into one scorecard,

e₂ indicates that an overall combination of letters acquired by replacing a combination of letters in the trademark by a combination of sound-approximate letters is segmented into one scorecard respectively,

e₃ indicates that a sound syllable of each numeral in the trademark is segmented into one scorecard, and

e₄ indicates that a sound syllable of each symbol in the trademark is segmented into one scorecard;

F. a trademark scorecard standard consisting of multiple combination schemes of the sound feature minimum units the elements of which are graphs, comprising: a scorecard standard f₁, wherein f₁ indicates that a pinyin of a name of each thing corresponding to the trademark graph element code is segmented into one scorecard;

G. a trademark scorecard standard consisting of multiple combination schemes of the meaning feature minimum units the elements of which are Chinese characters, comprising: at least one of scorecard standards g₁, g₂, g₃ and g₄, wherein:

g₁ indicates that the trademark completely contains existing Chinese character trademarks in a trademark server, and the entire trademark is meaningless, and the part containing the existing Chinese character trademarks is segmented into one scorecard,

g₂ indicates that the vocabularies recorded in the Chinese dictionary or a combination of Chinese characters of the existing Chinese character trademarks in the trademark server are completely matched with the trademark, and the matching parts are segmented into one scorecard respectively,

g₃ indicates that Chinese vocabularies contained in the trademark after being replaced by synonyms are segmented into one scorecard respectively, and

g₄ indicates that the overall trademark is meaningless, and the overall Chinese characters are segmented into one scorecard;

H. a trademark scorecard standard consisting of multiple combination schemes of the meaning feature minimum units the elements of which are letters, numerals and symbol combinations, comprising: at least one of scorecard standards h₁, h₂, h₃, h₄, h₅, h₆, h₇, h₈ and h₉, wherein:

h₁ indicates that the overall combination of letters of the trademark is composed of a combination of words recorded in an English dictionary or dictionary in other languages, and the overall combination of words is segmented into one scorecard,

h₂ indicates that the trademark contains words recorded in the English dictionary or dictionary in other languages, and each word is segmented into one scorecard,

h₃ indicates that the trademark contains words recorded in the English dictionary or dictionary in other languages, and a synonym of each word is segmented into one scorecard,

h₄ indicates that the overall combination of letters of the trademark is not matched with the words recorded in the English dictionary or dictionary in other languages, and the overall combination of letters is segmented into one scorecard,

h₅ indicates that each group of numerals separated in the trademark is segmented into one scorecard,

h₆ indicates that the overall combination of numerals of the trademark is segmented into one scorecard,

h₇ indicates that the overall combination of symbols of the trademark is segmented into one scorecard,

h₈ indicates that each symbol of the trademark is segmented into one scorecard, and

h₉ indicates that the trademark completely contains a trademark of the existing combination of letters in the trademark server, and the entire trademark is meaningless, and a part containing the trademark of the existing combination of letters is segmented into one scorecard;

I. a trademark scorecard standard consisting of multiple combination schemes of the meaning feature minimum units the elements of which are graphs, comprising: at least one of scorecard standards i₁ and i₂, wherein:

i₁ indicates that the name of each thing corresponding to the trademark graph element code is segmented into one scorecard, and

i₂ indicates that the trademark image feature descriptors correspond to the trademark graph element codes, and the name of each thing corresponding to the trademark graph element codes is segmented into one scorecard; and

Y. a trademark scorecard standard consisting of multiple combination schemes of minimum units the elements of which are exceptional adjustment characters, comprising: at least one of scorecard standards y₁ and y₂, wherein:

y₁ indicates that the trademark contains the exceptional adjustment characters, and the overall exceptional adjustment characters are segmented into one scorecard, and

y₂ indicates that the trademark contains the exceptional adjustment characters, and each character of the overall exceptional adjustment characters is segmented into one scorecard respectively.

Preferably, the exceptional adjustment characters comprise more than one of the following characters: geographical names of administrative areas above the county level, foreign geographical names known to the public, generic names of commodities, vocabularies indicating quality, main materials, functions, uses, weights, quantities, and other characteristics of commodities, generic names of commodities and services, characters with weak significance. The characters with weak significance refer to self-defined characters that do not have significant features of the trademark. In the embodiment, the exceptional adjustment characters are recorded in a basic name dictionary library, comprising a dictionary table of countries and regions in the world, a dictionary table of geographical names of administrative areas above the county level, a dictionary table of foreign city names, a dictionary table of forbidden words.

The “input trademark scorecard information” in the step S120 of the method for evaluating and sorting similarities of trademark query results, comprises: U₀, β₁, V₀, β₂, M₀ and Y₀, wherein U₀ indicates a number of scorecards of the input trademarks acquired on the basis of the trademark scorecard standards a₁₃, b₁₄, c₂, c₄ or a combination thereof; β₁ indicates a number of scorecards or a number of characters of the exceptional adjustment characters contained in the input trademarks and acquired on the basis of the scorecard standards a₁₃, b₁₄, c₂ and c₄; V₀ indicates a number of scorecards of the input trademarks acquired on the basis of the trademark scorecard standards d₁, d₂, d₃, e₁, e₂, e₃, e₄ or a combination thereof; β₂ indicates a number of scorecards or a number of syllables of the exceptional adjustment characters contained in the input trademarks and acquired on the basis of the scorecard standards d₁, d₂, d₃, e₁, e₂, e₃ and e₄; M₀ indicates a number of scorecards of the input trademarks after removing the exceptional adjustment characters matched with the scorecards of the resultant trademarks acquired on the basis of the trademark scorecard standards g₁, g₂, g₃ and g₄; and Y₀ indicates a number of scorecards of the input trademark acquired on the basis of the trademark scorecard standard y₁ or y₂;

the “scorecard information and scorecard matching information of the resultant trademarks” in the step S130 comprise Yₐ, Uₐ, U_{b}, U_{c}, Vₐ, V_{b}, V_{c}, M₁, M₂, M₃, M₄, Jᵢ, n, kᵢ, r and Tᵢ, wherein Yₐ indicates a number of scorecards of the resultant trademarks acquired on the basis of the trademark scorecard standard y₁ or y₂; Uₐ indicates a number of scorecards of the resultant trademarks after removing the exceptional adjustment characters matched with the scorecards of the input trademarks acquired on the basis of the trademark scorecard standards a₁₃, b₁₄, c₂, c₄ or a combination thereof; U_{b} indicates a number of scorecards of the resultant trademarks after removing the exceptional adjustment characters matched with the scorecards of the input trademarks acquired on the basis of the trademark scorecard standards a₁₀, b₁₀ or a combination thereof; U_{c} indicates a number of places where mismatched scorecards are inserted between the matched scorecards of the resultant trademarks and the input trademarks acquired on the basis of the trademark scorecard standards a₁₃, b₁₄, c₂, c₄ or a combination thereof and the trademark scorecard standards a₁₀, b₁₀ or a combination thereof; Vₐ indicates a number of scorecards of the resultant trademarks after removing the exceptional adjustment characters matched with the scorecards of the input trademarks acquired on the basis of the trademark scorecard standards d₁, d₂, e₁, e₃, e₄ or a combination thereof; V_{b} indicates a number of scorecards of the resultant trademarks after removing the exceptional adjustment characters matched with the scorecards of the input trademarks acquired on the basis of the trademark scorecard standards d₃, e₂ or a combination thereof; V_{c} indicates a number of places where mismatched scorecards are inserted between the matched scorecards of the resultant trademarks and the input trademarks acquired on the basis of the trademark scorecard standards d₁, d₂, e₁, e₃, e₄ or a combination thereof and the trademark scorecard standards d₃, e₂ or a combination thereof; M₁ indicates a compared number of scorecards of the resultant trademarks after removing the exceptional adjustment characters matched with the input trademarks on the basis of the trademark scorecard standard g₁; M₂ indicates a compared number of scorecards of the resultant trademarks after removing the exceptional adjustment characters matched with the input trademarks on the basis of the trademark scorecard standard g₂; M₃ indicates a compared number of scorecards of the resultant trademarks after removing the exceptional adjustment characters matched with the input trademarks on the basis of the trademark scorecard standard g₃; M₄ indicates a compared number of scorecards of the resultant trademarks after removing the exceptional adjustment characters matched with the input trademarks on the basis of the trademark scorecard standard g₄; Jᵢ indicates a preset similarity evaluation score of the trademark scorecard standard corresponding to an i^{th} scorecard where the resultant trademarks are matched with the input trademarks; n indicates a number of scorecard items where the resultant trademarks are matched with the input trademarks; kᵢ indicates an average score of the preset similarity evaluation scores of the trademark scorecard standards corresponding to each scorecard where the resultant trademarks are matched with the input trademarks in an i^{th} feature type, r indicates a number of feature types of the resultant trademarks matched with the input trademarks; and Tᵢ indicates the highest score among the preset similarity evaluation scores of the trademark scorecard standards corresponding to each scorecard where the resultant trademarks are matched with the input trademarks in the i^{th} feature type; and

the feature type is a scorecard category acquired by classifying the trademark scorecard information by a preset classification standard.

The feature type, according to the shape, sound and meaning, comprises: a shape feature type, a sound feature type, and a meaning feature type; and, according to the contents of the elements, comprises: a Chinese character feature type, a letter character feature type, a numeral character feature type, a symbol character feature type, a graph element code graph feature type, and an image feature descriptor graph feature type.

Preferably, the “preset calculation formulas for a trademark shape similarity, a trademark meaning similarity, a trademark sound similarity and a scoring rate of retrieval keywork matching” in the step S140 of the method for evaluating and sorting similarities of trademark query results, comprise:

1) the calculation formula for a trademark shape similarity, comprising:

Wᵤₙᵢₜ=Uₐ/(U₀−β₁)+[U_{b}/(U₀−β₁)]×λ₁−[U_{c}/(U₀−β₁)]×λ₂

wherein, Wᵤₙᵢₜ indicates the trademark shape similarity, λ₁ and λ₂ are preset adjustment weights both ranging from 10% to 300%;

2) the calculation formula for a trademark sound similarity, comprising

S_{sound}=Vₐ/(V₀−β₂)+[V_{b}/(V₀−β₂)]×μ₁−[V_{c}/(V₀−β₂)]×μ₂

wherein, S_{sound} indicates the trademark sound similarity, μ₁ and μ₂ are preset adjustment weights both ranging from 10% to 300%;

3) the calculation formula for a trademark meaning similarity, comprising:

S_{meaning}[(M₁+M₂×α₁+M₃×α₂+M₄×α₃)/M₀]−θ

wherein, S_{meaning} indicates the trademark meaning similarity, α₁, α₂ and α₃ respectively indicate adjustment parameters for M₂, M₃ and M₄, and value rules are as follows: when two or more parameters of M₁, M₂, M₃ and M₄ are not 0 at the same time, the first parameter in M₁, M₂, M₃ and M₄ is a valid parameter, and the rest are invalid parameters, and when M₁ is not 0, α₁, α₂ and α₃ are 0; when M₁ is 0 and M₂ is not 0, α₁, α₂ and α₃ are 0; when M₁ and M₂ are 0, and M₃ is not 0, α₂ is 1, and α₃ is 0; when M₁, M₂ and M₃ are 0, and M₄ is not 0, α₃ is 1; and θ indicates an adjustment parameter adjustment with different number of trademark characters between the input trademarks and the compared resultant trademarks, ranging from 1% to 90%; and

4) the calculation formula for a scoring rate of retrieval keywork matching, comprising at least one of the followings: a comprehensive average scoring rate of retrieval keywork matching, an average scoring rate of retrieval keywork matching classification, a highest scoring rate of retrieval keywork matching classification, and a highest weighted scoring rate of retrieval keywork matching classification, namely:

S_{keywork}=S₁, or S_{keywork}=S₂, S_{keywork}=S₃, or S_{keywork}=S₄

wherein, S_{keywork} indicates the scoring rate of retrieval keywork matching, S₁ indicates the comprehensive average scoring rate of retrieval keywork matching, S₂ indicates the average scoring rate of retrieval keywork matching classification, S₃ indicates the highest scoring rate of retrieval keywork matching classification, and S₄ indicates the highest weighted scoring rate of retrieval keywork matching classification; and

calculation formulas for S₁, S₂, S₃ and S₄ are respectively as follows:

S₁=J₁+J₂+J₃+ . . . +Jₙ/n

S₂=(k₁+k₂+k₃+ . . . +kᵣ)/r

S₃=(T₁+T₂+T₃+ . . . +Tᵣ)/r

S₄=T₁×ω₁+T₂×ω₂+T₃×ω₃+ . . . +Tᵣ×ωᵣ

wherein, ω₁, ω₂, ω₃, . . . , and ωᵣ respectively indicate calculation weights of highest scores in the preset similarity evaluation scores of the scorecard standards corresponding to the scorecards where the resultant trademarks are matched with the input trademarks in a first feature type, a second feature type, a third feature type, . . . , and an r^{th} feature type, and ω₁, ω₂, ω₃, . . . and ωᵣ range from 1% to 80%, and the total of all the calculation weights is 100%.

Further preferably, the “calculation formula for comprehensive quantified values of trademark similarity” in the step S150 of the method for evaluating and sorting similarities of trademark query results, comprises:

TMₙₑₐᵣ=Wᵤₙᵢₜ×Q₁+S_{sound}×Q₂+S_{meaning}×Q₃+S_{keywork}×Q₄

wherein, TMₙₑₐᵣ indicates the comprehensive quantified values of trademark similarity, Wᵤₙᵢₜ indicates the trademark shape similarity, S_{sound} indicates the trademark sound similarity, S_{meaning} indicates the trademark meaning similarity, S_{keywork} indicates the scoring rate of retrieval keywork matching, Q₁, Q₂, Q₃ and Q₄ respectively indicate weights of the trademark shape similarity, the trademark sound similarity, the trademark meaning similarity and the scoring rate of retrieval keywork matching, Q₁, Q₂, Q₃ and Q₄ range from 5% to 95%, and the total of all the calculation weights is 100%.

According to another aspect, the present invention further provides a device for evaluating and sorting similarities of trademark query results, comprising:

a scorecard preprocessing module for a sample trademark: configured to perform trademark scorecard processing on sample trademark images and contents according to preset trademark scorecard standards, wherein a specific processing procedure comprises: (1) establishing a trademark scorecard standard consisting of preset multiple combination schemes of shape feature minimum units, preset multiple combination schemes of sound feature minimum units, and preset multiple combination schemes of meaning feature minimum units, (2) identifying whether the sample trademarks contain elements of Chinese characters, graphs, letters, numerals or symbols, and acquiring contents of the elements, (3) extracting a shape feature minimum unit, a sound feature minimum unit and a meaning feature minimum unit of each element of the sample trademarks, and (4) according to the established trademark scorecard standard, extracting segmentation information of various characters and graphs generated or converted by each combination scheme, using the segmentation information as the sample trademark scorecard information, and setting a similarity evaluation score for each preset trademark scorecard standard;

a scorecard processing module for an input trademark: configured to perform trademark scorecard processing on input trademark images and contents according to preset trademark scorecard standards, wherein a specific processing procedure comprises: (1) establishing a trademark scorecard standard consisting of preset multiple combinations of shape feature minimum units, preset multiple combinations of sound feature minimum units, and preset multiple combinations of meaning feature minimum units, (2) identifying whether the input trademark contains elements of Chinese characters, graphs, letters, numbers or symbols, and acquiring contents of the elements, (3) extracting a shape feature minimum unit, a sound feature minimum unit and a meaning feature minimum unit of each element of the input trademark, and (4) according to the established trademark scorecard standard, extracting segmentation information of various characters and graphs generated or converted by each combination scheme, and using the segmentation information as input trademark scorecard information;

a trademark retrieving module: configured to retrieve the sample trademark scorecard information stored in a trademark storage by using an input trademark scorecard information set as a retrieval keywork, and acquire scorecard information and scorecard matching information of relevant resultant trademarks;

a calculation module for a trademark shape similarity: configured to calculate a trademark shape similarity between the input trademarks and the resultant trademarks according to a preset calculation formula for a trademark shape similarity;

a calculation module for a trademark meaning similarity: configured to calculate a trademark meaning similarity between the input trademarks and the resultant trademarks according to a preset calculation formula for a trademark meaning similarity;

a calculation module for a trademark sound similarity: configured to calculate a trademark sound similarity between the input trademarks and the resultant trademarks according to a preset calculation formula for a trademark sound similarity;

a calculation module for a scoring rate of retrieval keywork matching: configured to calculate a scoring rate of retrieval keywork matching between the input trademarks and the resultant trademarks according to a preset calculation formula for a scoring rate of retrieval keywork matching; and

a calculation module for comprehensive quantified values of trademark similarity: configured to acquire comprehensive quantified values of trademark similarity by calculation according to a preset calculation formula for comprehensive quantified values of trademark similarity, and sort the resultant trademarks according to magnitudes of the comprehensive quantified values of trademark similarity.

### Beneficial Effects

The present invention utilizes the preset trademark scorecard standards to separately segment the input trademarks from different angles to acquire the shape feature minimum units, the sound feature minimum units, the meaning feature minimum units and the combinations thereof, and calculates the scoring rate of retrieval keywork matching, the shape similarity, the sound similarity and the meaning similarity between the resultant trademarks and the input trademarks, acquires the comprehensive quantified values of trademark similarity, and sorts the similarities according to the magnitudes of the comprehensive quantified values of similarities, can comprehensively reflect the similarities of the comprehensive features of shape, sound and meaning of the trademarks, and improve the accuracy ratio and the recall ratio of trademark sameness or similarity determination. The present invention uses the comprehensive quantified values of trademark similarity to effectively quantize abstract visual results of the trademark images, and greatly improve the quantitative evaluation level of the trademark similarity; The present invention improves the standardization level of the trademark sameness or similarity determination, and narrows the difference between the similarity sorting results of the trademark query results and the sorting results of the trademark sameness or similarity in the sense of the Trademark Law expected by the examiners, preferably evaluates whether the input trademarks and the sample trademarks constitute the trademark sameness or similarity, and accelerates the progress of trademark examination. Moreover, the present invention only needs to input the trademarks to be retrieved into the system once to acquire the optimal comprehensive sorting result, which overcomes the need for the existing trademark retrieval system to continuously perform human-computer interaction to acquire different sorting and display results, or avoids too subjective retrieval results caused by artificial screening.

### BRIEF DESCRIPTION OF THE DRAWINGS

FIG. 1 is a schematic diagram illustrating a flow chart of a method for evaluating and sorting similarities of trademark query results according to a first embodiment of the present invention.

FIG. 2 is an exemplary original drawing of a trademark according to the first embodiment of the present invention.

FIG. 3 is an image feature descriptor diagram of pixel points on a trademark image contour line acquired by using a 10×10 coordinate system standard for an apple graph trademark of FIG. 2n.

FIG. 4 is an image feature descriptor diagram of pixel points on a trademark image contour line acquired by using a 20×20 coordinate system standard for the apple graph trademark of FIG. 2n.

FIG. 5 is a screenshot of report interfaces of the first 24 resultant trademarks sorted by using comprehensive quantified values of trademark similarity in the first embodiment of the present invention.

FIG. 6 is a schematic structural diagram of a device for evaluating and sorting similarities of trademark query results according to the first embodiment of the present invention.

FIG. 7 is a schematic diagram illustrating a flow chart of a method for evaluating and sorting similarities of trademark query results according to a second embodiment of the present invention.

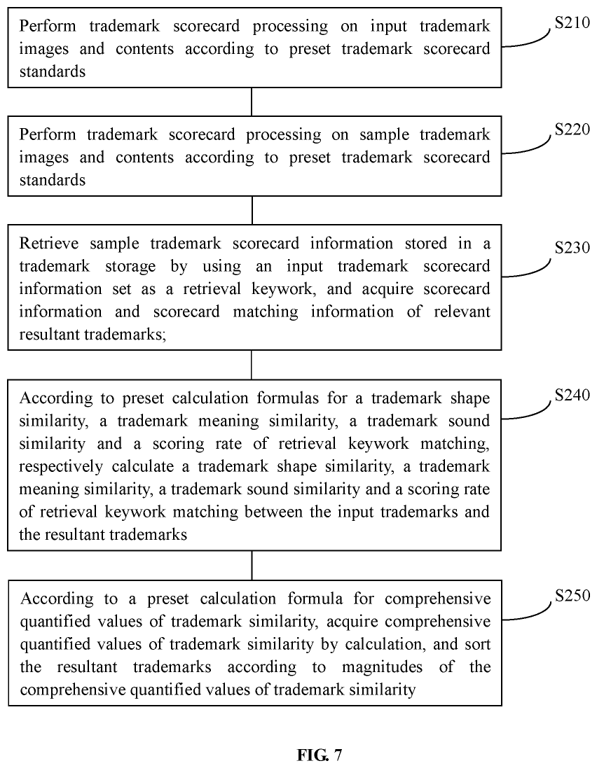

### DETAILED DESCRIPTION

To make the objects, technical solutions, and advantages of the present invention clearer, the present invention will be further described in details hereinafter with reference to the accompanying drawings and specific embodiments First embodiment

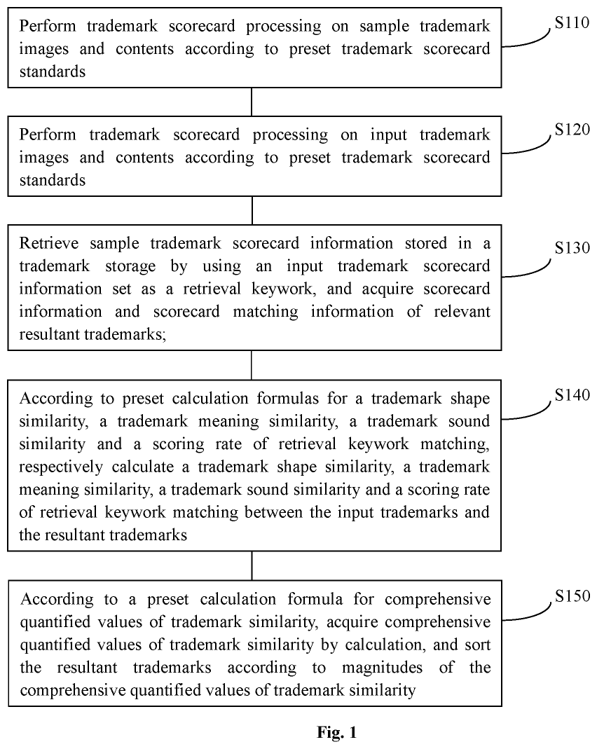

As shown in FIG. 1, a method for evaluating and sorting similarities of trademark query results, comprises the following steps:

step S110: performing trademark scorecard processing on sample trademark images and contents according to preset trademark scorecard standards, wherein a specific processing procedure comprises: (1) establishing a trademark scorecard standard consisting of preset multiple combination schemes of shape feature minimum units, preset multiple combination schemes of sound feature minimum units, and preset multiple combination schemes of meaning feature minimum units, (2) identifying whether the sample trademarks contain elements of Chinese characters, graphs, letters, numerals or symbols, and acquiring contents of the elements, (3) extracting a shape feature minimum unit, a sound feature minimum unit and a meaning feature minimum unit of each element of the sample trademarks, and (4) according to the established trademark scorecard standard, extracting segmentation information of various characters and graphs generated or converted by each combination scheme, using the segmentation information as the sample trademark scorecard information, and setting a similarity evaluation score for each preset trademark scorecard standard;

step S120: performing trademark scorecard processing on input trademark images and contents according to preset trademark scorecard standards, wherein a specific processing procedure comprises: (1) establishing a trademark scorecard standard consisting of preset multiple combination schemes of shape feature minimum units, preset multiple combination schemes of sound feature minimum units, and preset multiple combination schemes of meaning feature minimum units, (2) identifying whether the input trademarks contain elements of Chinese characters, graphs, letters, numerals or symbols, and acquiring contents of the elements, (3) extracting a shape feature minimum unit, a sound feature minimum unit and a meaning feature minimum unit of each element of the input trademarks, and (4) according to the established trademark scorecard standard, extracting segmentation information of various characters and graphs generated or converted by each combination scheme, and using the segmentation information as input trademark scorecard information;

step S130: retrieving the sample trademark scorecard information stored in a trademark storage by using an input trademark scorecard information set as a retrieval keywork, and acquiring scorecard information and scorecard matching information of relevant resultant trademarks;

step S140: according to preset calculation formulas for a trademark shape similarity, a trademark meaning similarity, a trademark sound similarity and a scoring rate of retrieval keywork matching, respectively calculating a trademark shape similarity, a trademark meaning similarity, a trademark sound similarity and a scoring rate of retrieval keywork matching between the input trademarks and the resultant trademarks; and

step S150: according to a preset calculation formula for comprehensive quantified values of trademark similarity, acquiring comprehensive quantified values of trademark similarity by calculation, and sorting the resultant trademarks according to magnitudes of the comprehensive quantified values of trademark similarity.

The above steps are specifically described below based on the specific embodiments. It should be emphasized that, in order to facilitate understanding, the first, second, third, fourth, and fifth steps are set in the embodiment, and in actual applications, the orders among the steps can be adjusted according to requirements.

First, in the step S110, trademark scorecard processing is performed on sample trademark images and contents according to preset trademark scorecard standards, wherein a specific processing procedure comprises: (1) establishing a trademark scorecard standard consisting of preset multiple combination schemes of shape feature minimum units, preset multiple combination schemes of sound feature minimum units, and preset multiple combination schemes of meaning feature minimum units, (2) identifying whether the sample trademarks contain elements of Chinese characters, graphs, letters, numerals or symbols, and acquiring contents of the elements, (3) extracting a shape feature minimum unit, a sound feature minimum unit and a meaning feature minimum unit of each element of the sample trademarks, and (4) according to the established trademark scorecard standard, extracting segmentation information of various characters and graphs generated or converted by each combination scheme, and using the segmentation information as sample trademark scorecard information, and setting a similarity evaluation score for each predetermined preset trademark scorecard standard.

(1) Establish the trademark scorecard standard consisting of preset multiple combination schemes of shape feature minimum units, preset multiple combination schemes of sound feature minimum units, and preset multiple combination schemes of meaning feature minimum units.

Whether two trademarks constitute a similarity can be generally judged from the aspect whether the two trademarks have commonality in shape, meaning, and sound. How to find out the commonality of the two trademarks and the ratio of the common components are technical problems to be solved in the embodiments of the present invention. Therefore, the embodiments of the present invention can acquire the beneficial technical effects in the similarity evaluating and sorting process of the trademark query results by establishing the trademark scorecard standards through the minimum constituent units subdivided in the aspects of shape, meaning and sound, and the combinations of the minimum units.

Subdividing the minimum constituent units of the trademarks in the aspects of shape, meaning and sound comprises:

1) the shape feature minimum units comprising:

a shape feature minimum unit the elements of which are Chinese characters, and selected from one of the followings: each Chinese character, and each stroke of each Chinese character;

a shape feature minimum unit the elements of which are graphs, and selected from one of the followings: a trademark graph element code, and a pixel set with a preset length on a trademark image contour line;

a shape feature minimum unit the elements of which are letters, and selected from one of the followings: words in each language, and each letter;

a shape feature minimum unit the elements of which are Chinese numerals, and selected from one of the followings: a combination of Chinese numerals, and each single Chinese numeral;

a shape feature minimum unit the elements of which are Arabic numerals, and selected from one of the followings: a combination of Arabic numerals, and each single Arabic numeral;

a shape feature minimum unit the elements of which are numerals in other languages, and selected from one of the followings: a combination of numerals in other languages, and each single numeral in other languages; and a shape feature minimum unit the elements of which are symbols: each signal symbol;

2) the meaning feature minimum units comprising:

a meaning feature minimum unit the elements of which are Chinese characters: when an overall combination of Chinese characters of a trademark is composed of a combination of vocabularies recorded in a Chinese dictionary, each vocabulary is the meaning feature minimum unit; otherwise, the overall combination of Chinese characters of the trademark is the meaning feature minimum unit;

a meaning feature minimum unit the elements of which are graphs: a name of each thing corresponding to the trademark graph element code;

a meaning feature minimum unit the elements of which are letters: when an overall combination of letters of the trademark is composed of a combination of words recorded in an English dictionary, or a combination of words recorded in a dictionary in other languages, each word is the meaning feature minimum unit; otherwise, the overall letter combination of the trademark is the meaning feature minimum unit;

a meaning feature minimum units the elements of which are Chinese numerals, and selected from one of the followings: numerals in a preset reference language corresponding to each group of Chinese numerals separated in the trademark, and numerals in a preset reference language corresponding to each single Chinese numeral in the trademark, wherein the numerals in the preset reference language are numerals in any languages;

a meaning feature minimum units the elements of which are Arabic numerals, and selected from one of the followings: numerals in a preset reference language corresponding to each group of Arabic numerals separated in the trademark, and numerals in a preset reference language corresponding to each single Arabic numeral in the trademark, wherein the numerals in the preset reference language are numerals in any languages;

a meaning feature minimum units the elements of which are numerals in other languages, and selected from one of the followings: numerals in a preset reference language corresponding to each group of numeral in other languages separated in the trademark, and numerals in a preset reference language corresponding to each single numeral in other languages in the trademark, wherein the numerals in the preset reference language are numerals in any languages; and

a meaning feature minimum units the elements of which are symbols: a symbolic name corresponding to each symbol in the trademark;

3) the sound feature minimum units comprising:

a sound feature minimum units the elements of which are Chinese characters: Pinyin of each Chinese character;

a sound feature minimum unit the elements of which are graphs: Pinyin of a name of each thing corresponding to the trademark graph element code;

a sound feature minimum units the elements of which are letters, and selected from one of the followings: a sound of each combination of letters, and a sound of each letter; and

a sound feature minimum units the elements of which are numerals or symbols, and selected from one of the followings: a sound of each group of numerals separated in the trademark, a sound of each single numeral, a sound of each group of symbols separated in the trademark, and a sound of each single symbol; and

a trademark scorecard standard consisting of preset shape feature, sound feature and meaning feature minimum units and multiple combination schemes thereof comprises the followings.

A. A trademark scorecard standard consisting of multiple combination schemes of the shape feature minimum units the elements of which are Chinese characters, comprises: at least one of scorecard standards a₁, a₂, a₃, a₄, a₅, a₆, a₇, a₈, a₉, a₁₀, a₁₁, a₁₂ and a₁₃, wherein:

a₁ indicates that an overall combination of characters in all languages and graph element codes of the trademark arranged in order is segmented into one scorecard,

a₂ indicates that an overall combination of characters in all languages and graph element codes of the trademark arranged in a reversed order is segmented into one scorecard,

a₃ indicates that Chinese characters in the trademark arranged in order are segmented into one scorecard,

a₄ indicates that Chinese characters in the trademark arranged in a reversed order are segmented into one scorecard,

a₅ indicates that Chinese numerals in the trademark arranged in order are segmented into one scorecard,

a₆ indicates that Chinese numerals in the trademark arranged in a reversed order are segmented into one scorecard,

a₇ indicates that each relatively independent part in the trademark is segmented into one scorecard respectively,

a₈ indicates that the characters in the trademark completely contain the existing trademark in Chinese characters, and the part is segmented into one scorecard,

a₉ indicates that traditional and variant Chinese characters contained in the trademark are converted into simplified Chinese characters and then segmented into one scorecard,

a₁₀ indicates that each character in the trademark after being replaced by a shape-approximate character is segmented into one scorecard,

a₁₁ indicates that every adjacent Chinese characters in the trademark are segmented into one scorecard respectively,

a₁₂ indicates that a combination of first and last Chinese characters in the trademark is segmented into one scorecard, and

a₁₃ indicates that each Chinese character in the trademark is segmented into one scorecard.

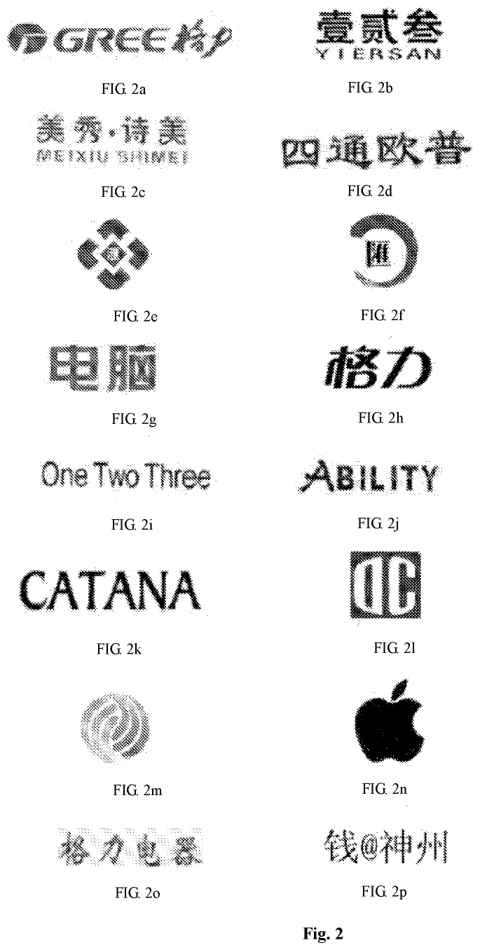

A processing method of the trademark scorecard rules will be described below with reference to various trademark patterns in FIG. 2.

a₁ indicates that an overall combination of characters in all languages and graph element codes of a trademark arranged in order is segmented into one scorecard. That is, for all the characters and graph element codes contained in the trademark, regardless of Chinese characters or characters in other languages, a combination of letters, a combination of numerals, and a combination of symbols or other elements, or whether they can constitute a vocabulary with a common meaning, the overall combination of characters in all languages and the graph element codes of the trademark arranged in order is segmented into one scorecard. Taking FIG. 2a for example, it is segmented into “ [symbol] GREE+26.1.10” scorecard according to the trademark scorecard standard, and taking FIG. 2c for example, it is segmented into “ [symbol] ⋅ [symbol] MEIXIUSHIMEI” scorecard according to the trademark scorecard standard.

a₂ indicates that an overall combination of characters in all languages and graph element codes of the trademark arranged in a reversed order is segmented into one scorecard. That is, for all the characters contained in the trademark, regardless of Chinese characters or characters in other languages, a combination of letters, a combination of numerals, and a combination of symbols or other elements, or whether they can constitute a vocabulary with a common meaning, the overall combination of characters in all languages and the graph element codes of the trademark arranged in a reversed order is segmented into one scorecard. Taking FIG. 2a for example, it is segmented into “26.1.10+EERG [symbol] scorecard according to the trademark scorecard standard, and taking FIG. 2c for example, it is segmented into “IEMIHSUIXIEM [symbol] ⋅ [symbol] ” scorecard according to the trademark scorecard standard. A minimum unit of characters is a single character, and orders of multiple characters can be changed; Minimum units of letters, numerals and symbols are a single letter, a single letter and a single symbol, and orders of combinations of multiple letters, numbers and symbol can be replaced; The entire graph element code “26.1.10” is the shape feature minimum unit, and orders of numerals thereof cannot be changed, but orders of multiple graph element codes can be changed (the same below).

a₃ indicates that Chinese characters in the trademark arranged in order are segmented into one scorecard. That is, the entire Chinese characters contained in the trademark are arranged in order and regarded as one scorecard. Taking FIG. 2c for example, it is segmented into “ [symbol] ” scorecard according to the trademark scorecard standard.

a₄ indicates that Chinese characters in the trademark arranged in a reversed order are segmented into one scorecard. That is, the entire Chinese characters contained in the trademark are arranged in a reversed order and regarded as one scorecard. Taking FIG. 2c for example, it is segmented into “ [symbol] ” scorecard according to the trademark scorecard standard.

a₅ indicates that Chinese numerals in the trademark arranged in order are segmented into one scorecard. That is, the trademark contains Chinese numerals, and the Chinese numerals and Arabic numerals corresponding to the Chinese numerals are entirely arranged in order and regarded as one scorecard respectively. Taking FIG. 2b for example, it is segmented into “ [symbol] ” and “123” scorecards according to the trademark scorecard standard.

a₆ indicates that Chinese numerals in the trademark arranged in a reversed order are segmented into one scorecard. That is, the trademark contains Chinese numerals, and the Chinese numerals and Arabic numerals corresponding to the Chinese numerals are entirely arranged in a reversed order and regarded as one scorecard respectively. Taking FIG. 2b for example, it is segmented into “ [symbol] ” and “321” scorecards according to the trademark scorecard standard.

a₇ indicates that each relatively independent part in the trademark is segmented into one scorecard respectively. That is, the trademark contains relative independence parts, and the relatively independent parts are regarded as one scorecard respectively. Taking FIG. 2c for example, it is segmented into “ [symbol] ”, “ [symbol] ” and “MEIXIU SHIMEI” scorecards according to the trademark scorecard standard. The distinguishing rules of the relatively independent part comprise: different relatively independent parts distinguished from different languages, and different relatively independent parts combined by the characters in the same language separated by symbols or spaces, and different relatively independent parts combined by the characters in the same language but different colors.

a₈ indicates that the characters in the trademark completely contain the existing trademark in Chinese characters, and the part is segmented into one scorecard. That is, the trademark contains prior Chinese characters of others, and the part of the prior Chinese characters of others is regarded as one scorecard. Taking FIG. 2d for example, it is supposed that the prior trademarks of others comprise “ [symbol] ” and “ [symbol] ”, and are segmented into “ [symbol] [symbol] ” and “ [symbol] ” scorecards according to the trademark scorecard standard.

a₉ indicates that traditional and variant Chinese characters contained in the trademark are converted into simplified Chinese characters and then segmented into one scorecard. That is, the trademark contains traditional and variant Chinese characters, and the traditional and variant Chinese characters are converted into simplified Chinese characters and then regarded as one scorecard. Taking FIG. 2e and FIG. 2f for example, the traditional character “ [symbol] ” and the variant Chinese character “ [symbol] ” in the trademark are respectively segmented into a scorecard of simplified Chinese character “ [symbol] ” according to the trademark scorecard standard.

a₁₀ indicates that each character in the trademark is replaced by a similar character, and then segmented into one scorecard. That is, the trademark contains shape-approximate characters, and a combination of the shape-approximate characters is regarded as one scorecard. Taking FIG. 2h for example, it is respectively segmented into “ [symbol] [symbol] ”, “ [symbol] ”, “ [symbol] ”, “ [symbol] ”, “ [symbol] ”, “ [symbol] ”, “ [symbol] ” and “ [symbol] ” scorecards according to the trademark scorecard standard.

a₁₁ indicates that every adjacent Chinese characters in the trademark are segmented into one scorecard respectively. That is, when the number of Chinese characters in the trademark is three or more, every two adjacent Chinese characters in the trademark are regarded as one scorecard. Taking FIG. 2d for example, it is respectively segmented into “ [symbol] [symbol] ”, “ [symbol] ” and “ [symbol] ” scorecards according to the trademark scorecard standard.

a₁₂ indicates that first and last Chinese character combinations in the trademark are segmented into one scorecard. That is, when the number of Chinese characters in the trademark is three or more, the first and last Chinese characters in the trademark are regarded as one scorecard. Taking FIG. 2d for example, it is respectively segmented into “ [symbol] [symbol] ” scorecard according to the trademark scorecard standard.

a₁₃ indicates that each Chinese character in the trademark is segmented into one scorecard. That is, each Chinese character in the trademark is regarded as one scorecard. Taking FIG. 2d for example, it is respectively segmented into “ [symbol] ”, “ [symbol] ”, “ [symbol] ” and “ [symbol] ” scorecards according to the trademark scorecard standard.

B. A trademark scorecard standard consisting of multiple combination schemes of the shape feature minimum units the elements of which are letters, numerals and symbols, comprises: at least one of scorecard standards b₁, b₂, b₃, b₄, b₅, b₆, b₇, b₈, b₉, b₁₀, b₁₁, b₁₂, b₁₃ and b₁₄, wherein:

b₁ indicates that an overall combination of characters in all languages and graph element codes of the trademark arranged in order is segmented into one scorecard,

b₂ indicates that the overall combination of characters in all languages and graph element codes of the trademark arranged in a reversed order is segmented into one scorecard,

b₃ indicates that a combination of letters in the trademark arranged in order is segmented into one scorecard,

b₄ indicates that a combination of letters in the trademark arranged in a reversed order is segmented into one scorecard,

b₅ indicates that non-Chinese numerals contained in the trademark arranged in order or each single non-Chinese numeral is segmented into one scorecard respectively.

b₆ indicates that non-Chinese numerals contained in the trademark arranged in a reversed order or each single non-Chinese numeral is segmented into one scorecard respectively,

b₇ indicates that a combination of symbols contained in the trademark arranged in order is segmented into one scorecard,

b₈ indicates that a combination of symbols contained in the trademark arranged in a reversed order is segmented into one scorecard,

b₉ indicates that each relatively independent part in the trademark is segmented into one scorecard respectively,

b₁₀ indicates that each letter in the trademark after being replaced by a shape-approximate letter is segmented into one scorecard,

b₁₁ indicates that a combination of every adjacent letters in the trademark is segmented into one scorecard respectively,

b₁₂ indicates that letters in the trademark are arranged in different orders, and then segmented into one scorecard respectively,

b₁₃ indicates that a combination of first and last letters in the trademark is segmented into one scorecard, and

b₁₄ indicates that each letter, or numeral, or symbol in the trademark is segmented into one scorecard respectively.

A processing method of the trademark scorecard rules will be described below with reference to various trademark patterns in FIG. 2.

b₁ indicates that an overall combination of characters in all languages and graph element codes of a trademark arranged in order is segmented into one scorecard. That is, for all the characters and graph element codes contained in the trademark, regardless of Chinese characters or characters in other languages, a combination of letters, a combination of numerals, and a combination of symbols or other elements, or whether they can constitute a vocabulary with a common meaning, the overall combination of characters in all languages and the graph element codes of the trademark arranged in order is segmented into one scorecard. Taking FIG. 2a for example, it is segmented into “ [symbol] GREE+26.1.10” scorecard according to the trademark scorecard standard, and taking FIG. 2c for example, it is segmented into “ [symbol] ⋅ [symbol] MEIXIUSHIMEI” scorecard according to the trademark scorecard standard.

b₂ indicates that an overall combination of characters in all languages and graph element codes of the trademark arranged in a reversed order is segmented into one scorecard. That is, for all the characters contained in the trademark, regardless of Chinese characters or characters in other languages, a combination of letters, a combination of numerals, and a combination of symbols or other elements, or whether they can constitute a vocabulary with a common meaning, the overall combination of characters in all languages and the graph element codes of the trademark arranged in a reversed order is segmented into one scorecard. Taking FIG. 2a for example, it is segmented into “26.1.10+EERG [symbol] ” scorecard according to the trademark scorecard standard, and taking FIG. 2c for example, it is segmented into “IEMIHSUIXIEM [symbol] ⋅ [symbol] ” scorecard according to the trademark scorecard standard.

b₃ indicates that a combination of letters in the trademark arranged in order is segmented into one scorecard. That is, the trademark contains a combination of letters, and the entire letters are arranged in order and regarded as one scorecard. Taking FIG. 2c for example, it is segmented into “MEIXIUSHIMEI” scorecard according to the trademark scorecard standard.

b₄ indicates that a combination of letters in the trademark arranged in a reversed order is segmented into one scorecard. That is, the trademark contains a combination of letters, and the entire letters are arranged in a reversed order and regarded as one scorecard. Taking FIG. 2c for example, it is segmented into “IEMIHSUIXIEM” scorecard according to the trademark scorecard standard.

b₅ indicates that non-Chinese numerals contained in the trademark arranged in order or each single non-Chinese numeral is segmented into one scorecard respectively. That is, the trademark contains non-Chinese numerals, and the non-Chinese numerals and Arabic numerals corresponding to the non-Chinese numerals are entirely arranged in order and regarded as one scorecard respectively. Taking FIG. 2i for example, it is segmented into “one two three” and “123” scorecards according to the trademark scorecard standard.

b₆ indicates that non-Chinese numerals contained in the trademark arranged in a reversed order or each single non-Chinese numeral is respectively segmented into one sub-cards. That is, the trademark contains non-Chinese numerals, and the non-Chinese numerals and Arabic numerals corresponding to the non-Chinese numerals are entirely arranged in a reversed order and regarded as one scorecard respectively. Taking FIG. 2i for example, it is segmented into “three two one” and “321” scorecards according to the trademark scorecard standard.

b₇ indicates that a combination of symbols contained in the trademark arranged in order is segmented into one scorecard. That is, the trademark contains a combination of symbols, and the overall combination of symbols is arranged in order and regarded as one scorecard respectively. Taking FIG. 2p for example, it is segmented into “@” scorecard according to the trademark scorecard standard.

b₈ indicates that symbol combinations contained in the trademark arranged in a reversed order are segmented into one scorecard. That is, the trademark contains a combination of symbols, and the overall combination of symbols is arranged in a reversed order and regarded as one scorecard respectively. Taking FIG. 2p for example, it is segmented into “@” scorecard according to the trademark scorecard standard.

b₉ indicates that each relatively independent part in the trademark is segmented into one scorecard respectively. That is, the trademark contains relative independence parts, and the relatively independent parts are regarded as one scorecard respectively. Taking FIG. 2c for example, it is segmented into “ [symbol] ”, “ [symbol] ” and “MEIXIU SHIMEI” scorecards according to the trademark scorecard standard. The distinguishing rules of the relatively independent part comprise: different relatively independent parts distinguished from different languages, and different relatively independent parts combined by the characters in the same language separated by symbols or spaces, and different relatively independent parts combined by the characters in the same language but different colors.

b₁₀ indicates that each letter in the trademark after being replaced by a shape-approximate letter is segmented into one scorecard. That is, the trademark contains shape-approximate letters, and a combination of the shape-approximate letters is regarded as one scorecard. Taking FIG. 2l for example, it is respectively segmented into “DC”, “DG”, “DO”, “OC”, “OO” and “OG” scorecards according to the trademark scorecard standard.

b₁₁ indicates that every adjacent letter combinations in the trademark are segmented into one scorecard respectively. That is, when the number of letters contained in the trademark is four or more, every n adjacent letters or numbers or symbols of the whole segment of letters, numbers and symbols of the trademark are regarded as one scorecard by an original order and sequencing plus the first letter. A value range of n is greater than 2 and less than 50% of the total number of letters. When the last remainder is less than one half of the preset number of letters (n), it is combined with the previous scorecard to form one scorecard, and when the last remainder is equal to or greater than one half, it is one independent scorecard. Taking FIG. 2k for example, when the value of n is 2, it is respectively segmented into “CA”, “CAT”, “CTA”, “CAN” and ““CNA” scorecards according to the trademark scorecard standard.

b₁₂ indicates that letters in the trademark are arranged in different orders, and then segmented into one scorecard respectively. That is, the combinations of letters respectively formed according to the fixed sequencing rules of the whole, words and 26 letters of the trademark are taken as one scorecard, and then the first letter is added as one scorecard, but the overall combination of letters of the entire trademark is meaningless and repeated letters should be removed from the scorecard consisting of the sequencing of the letters. Taking FIG. 2k for example, it is respectively segmented into “catana”, “acnt” and “cacnt” scorecards according to the trademark scorecard standard.

b₁₃ indicates that first and last letter combinations in the trademark are segmented into one scorecard. That is, when the trademark contains letters, numerals, symbols and combined vocabularies, the first and last letters or numerals or symbols in the trademark are regarded as one scorecard. Taking FIG. 2k for example, it is respectively segmented into “ca” scorecard according to the trademark scorecard standard.

b₁₄ indicates that each letter or numeral or symbol in the trademark is segmented into one scorecard respectively. That is, when the trademark contains letters, numerals, symbols and combined vocabularies, each letter or numeral or symbol in the trademark is regarded as one scorecard. Taking FIG. 2k for example, it is respectively segmented into “c”, “a”, “t” and “n” scorecards according to the trademark scorecard standard.

C. A trademark scorecard standard consisting of multiple combination schemes of the shape feature minimum units the elements of which are graphs, comprises: at least one of scorecard standards c₁, c₂, c₃ and c₄, wherein:

c₁ indicates that a trademark graph element code set is entirely segmented into one scorecard,

c₂ indicates that each trademark graph element code is segmented into one scorecard,

c₃ indicates that an entirety of trademark image feature descriptors generated by each image feature recognition method is segmented into one scorecard respectively, and

c₄ indicates that a preset length of the trademark image feature descriptor generated by each image feature recognition method is segmented into one scorecard respectively.

The preset length of the trademark image feature descriptor refers to a preset length of consecutively connected pixels on a trademark image contour line, the consecutively connected pixels are represented by a feature character string set or a numeral set, and a value ranges from 0.1% to 50% of an overall length of the trademark image feature descriptor or the numeral set.

A processing method of the trademark scorecard rules will be described below with reference to various trademark patterns in FIG. 2.

c₁ indicates that a trademark graph element code set is entirely segmented into one scorecard. That is, the trademark graph element codes of Vienna classification standard are generally used in the trademark industry to indicate features of the trademark graph at present. All the graph element codes of the trademark are entirely regarded as one scorecard. Taking FIG. 2m for example, the trademark graph element codes acquired through retrieving are 26.1.12a, 26.2.5 and 29.1.12, and are segmented into “26.1.12a, 26.2.5, 29.1.12” scorecard according to the trademark scorecard standard.

c₂ indicates that each trademark graph element code is segmented into one scorecard. That is, each graph element code of the trademark is regarded as one scorecard. Taking FIG. 2m for example, the trademark graph element codes acquired through retrieving are 26.1.12a, 26.2.5 and 29.1.12, and are respectively segmented into “26.1.12a”, “26.2.5” and “29.1.12” scorecards according to the trademark scorecard standard.

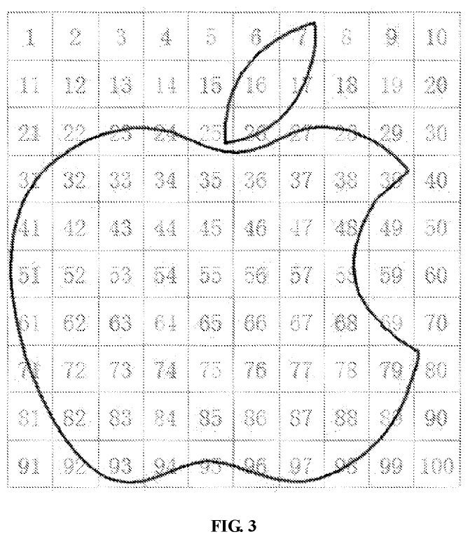

c₃ indicates that an entirety of trademark image feature descriptors generated by each image feature recognition method are segmented into one scorecard respectively. That is, the entirety of the trademark image feature descriptors generated by the trademark using each image feature recognition method is regarded as one scorecard. Taking FIG. 2n for example, the trademark image feature descriptors extracted by using a first image feature recognition method (method for extracting a pixel numeral set on an image contour line based on a 10×10 coordinate system standard) is as shown in FIG. 3, wherein values of the trademark image feature descriptors according to the sequencing (from small to large) are as follows:

6, 7, 15, 16, 17, 25, 26, 27,

22, 23, 24, 25, 26, 27, 28, 29, 31, 32, 39, 41, 48, 49, 51, 58, 61, 68, 69, 71, 79, 80, 81, 82, 89, 92, 93, 94, 95, 96, 97, 98, 99.

Values of the trademark image feature descriptors in order (in the order of every adjacent points along the contour line in the clockwise direction) are as follows:

6, 7, 17, 27, 26, 25, 15, 16,

22, 23, 24, 25, 26, 27, 28, 29, 39, 49, 48, 58, 68, 69, 79, 80, 79, 89, 99, 98, 97, 96, 95, 94, 93, 92, 82, 81, 71, 61, 51, 41, 31, 32.

It is respectively segmented into the following two scorecards according to the scorecard standard:

“6, 7, 15, 16, 17, 25, 26, 27; 22, 23, 24, 25, 26, 27, 28, 29, 31, 32, 39, 41, 48, 49, 51, 58, 61, 68, 69, 71, 79, 80, 81, 82, 89, 92, 93, 94, 95, 96, 97, 98, 99”; and

“6, 7, 17, 27, 26, 25, 15, 16; 22, 23, 24, 25, 26, 27, 28, 29, 39, 49, 48, 58, 68, 69, 79, 80, 79, 89, 99, 98, 97, 96, 95, 94, 93, 92, 82, 81, 71, 61, 51, 41, 31, 32”.

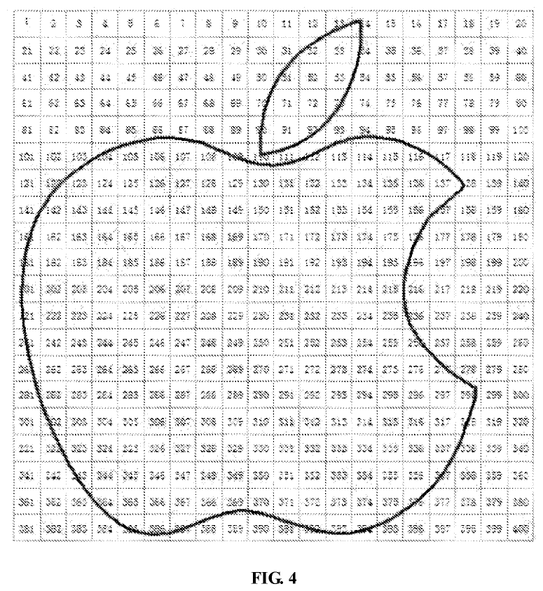

Taking FIG. 2n for example again, the trademark image feature descriptors extracted by using a second image feature recognition method (method for extracting a pixel numeral set on an image contour line based on a 20×20 coordinate system standard) is as shown in FIG. 4, wherein values of the trademark image feature descriptors according to the sequencing (from small to big) are as follows:

12, 13, 14, 31, 32, 34, 50, 51, 53, 54, 70, 73, 90, 91, 92, 93, 110, 111;

85, 86, 87, 88, 93, 94, 95, 96, 103, 104, 105, 108, 109, 110, 111, 112, 113, 116, 117, 122, 123, 137, 138, 141, 142, 156, 157, 161, 176, 181, 196, 201, 216, 221, 236, 241, 256, 257, 261, 277, 278, 281, 282, 298, 302, 318, 322, 323, 337, 338, 343, 357, 363, 364, 369, 370, 375, 376, 384, 385, 386, 387, 388, 390, 391, 392, 393, 394, 395.

Values of the trademark image feature descriptors in order (in the order of every adjacent points along the contour line in the clockwise direction) are as follows:

12, 13, 14, 34, 54, 53, 73, 93, 92, 91, 111, 110, 90, 70, 50, 51, 31, 32;

85, 86, 87, 88, 108, 109, 110, 111, 112, 113, 93, 94, 95, 116, 117, 137, 138, 157, 156, 176, 196, 216, 236, 256, 257, 277, 278, 298, 318, 338, 337, 357, 376, 375, 395, 394, 393, 392, 391, 390, 370, 369, 388, 387, 386, 385, 384, 364, 363, 344, 343, 323, 322, 302, 282, 281, 261, 241, 221, 201, 181, 161, 141, 142, 122, 123, 103, 104, 105.

It is respectively segmented into the following two scorecards according to the scorecard standard:

“12, 13, 14, 31, 32, 34, 50, 51, 53, 54, 70, 73, 90, 91, 92, 93, 110, 111; 85, 86, 87, 88, 93, 94, 95, 96, 103, 104, 105, 108, 109, 110, 111, 112, 113, 116, 117, 122, 123, 137, 138, 141, 142, 156, 157, 161, 176, 181, 196, 201, 216, 221, 236, 241, 256, 257, 261, 277, 278, 281, 282, 298, 302, 318, 322, 323, 337, 338, 343, 357, 363, 364, 369, 370, 375, 376, 384, 385, 386, 387, 388, 390, 391, 392, 393, 394, 395”; and

“12, 13, 14, 34, 54, 53, 73, 93, 92, 91, 111, 110, 90, 70, 50, 51, 31, 32; 85, 86, 87, 88, 108, 109, 110, 111, 112, 113, 93, 94, 95, 116, 117, 137, 138, 157, 156, 176, 196, 216, 236, 256, 257, 277, 278, 298, 318, 338, 337, 357, 376, 375, 395, 394, 393, 392, 391, 390, 370, 369, 388, 387, 386, 385, 384, 364, 363, 344, 343, 323, 322, 302, 282, 281, 261, 241, 221, 201, 181, 161, 141, 142, 122, 123, 103, 104, 105”.

c₄ indicates that a preset length of the trademark image feature descriptor generated by each image feature recognition method is segmented into one scorecard respectively. That is, each trademark image feature character string with a preset length of the trademark image feature descriptors (or trademark image feature information) generated by the trademark using each image feature recognition method is segmented into one scorecard respectively.

The preset length of the trademark image feature descriptor (or trademark image feature information) refers to consecutively partial trademark image feature descriptors within a certain length range and set according to a preset rule, which is represented by consecutively partial numeral or character set, and a value ranges from 0.1% to 50% of an overall length of the image feature descriptor. In this embodiment, the image feature descriptor is segmented into n image feature element units according to the following specific rules, and each image feature element unit is a preset length of one image feature descriptor:

1) according to segmenting lengths preset respectively by different coordinate system standards for acquiring the image feature descriptors, the preset segmenting lengths range from 10 to 100 characters;

2) not segmenting when the total number of the image feature descriptors is less than or equal to the preset segmenting length, and the entire image feature descriptors being regarded as image feature element unit;

3) when the total number of the image feature descriptors is greater than the preset segmenting length, segmenting the image feature descriptors into a plurality of groups by using the preset segmenting length as a standard, and each group being regarded as one image feature element unit;

4) a part of image feature descriptors of a specific connected domain feature being regarded as one image feature element unit; and

5) the last group segmented above less than 50% of the preset segmenting length being combined with the previous group into one image feature element unit, and remaining characters in the last group equal to or more than 50% of the preset segmenting length being one group and regarded as one image feature element unit.

Taking FIG. 2n for example again, it is supposed that five sets of numerals are taken for the values of the preset length, and the trademark image feature descriptors extracted by using the first image feature recognition method (method for extracting a pixel numeral set on an image contour line based on a 10×10 coordinate system standard), i.e., a method for extracting a pixel numeral set on a sequencing (from small to big) image contour line, is as shown in FIG. 3. Following 11 scorecards are respectively segmented according to the scorecard standard:

“6, 7, 15, 16, 17, 25, 26, 27”, “22, 23, 24, 25, 26, 27, 28, 29, 31, 32, 39, 41, 48, 49, 51, 58, 61, 68, 69, 71, 79, 80, 81, 82, 89, 92, 93, 94, 95, 96, 97, 98, 99”; and

“6, 7, 15, 16, 17”, “25, 26, 27”, “22, 23, 24, 25, 26”, “27, 28, 29, 31, 32”, “39, 41, 48, 49, 51”, “58, 61, 68, 69, 71”, “79, 80, 81, 82, 89”, “92, 93, 94, 95, 96”, “97, 98, 99”.

Taking FIG. 2n for example again, it is supposed that five sets of numerals are taken for the values of the preset length, and the trademark image feature descriptors extracted by using the first image feature recognition method (method for extracting a pixel numeral set on an image contour line based on a 20×20 coordinate system standard), i.e., a method for extracting a pixel numeral set on a sequencing (a sequence of adjacent points one by one in the clockwise direction of a contour line) image contour line, is as shown in FIG. 4. Following 11 scorecards are respectively segmented according to the scorecard standard:

“6, 7, 17, 27, 26, 25, 15, 16”, “22, 23, 24, 25, 26, 27, 28, 29, 39, 49, 48, 58, 68, 69, 79, 80, 79, 89, 99, 98, 97, 96, 95, 94, 93, 92, 82, 81, 71, 61, 51, 41, 31, 32”; and

“6, 7, 17, 27, 26”, “25, 15, 16”, “22, 23, 24, 25, 26”, “27, 28, 29, 39, 49”, “48, 58, 68, 69, 79”, “80, 79, 89, 99, 98”, “97, 96, 95, 94, 93”, “92, 82, 81, 71, 61”, “51, 41, 31, 32”.

D. A trademark scorecard standard consisting of multiple combination schemes of the sound feature minimum units the elements of which are Chinese characters, comprise: at least one of scorecard standards d₁, d₂ and d₃, wherein:

d₁ indicates that a Pinyin syllable of each Chinese character in the trademark is segmented into one scorecard,

d₂ indicates that Pinyin syllables corresponding to the overall Chinese characters in the trademark are segmented into one scorecard, and

d₃ indicates that the Pinyin syllable of each Chinese character in the trademark after being replaced by a shape-approximate character is segmented into one scorecard.

A processing method of the trademark scorecard rules will be described below with reference to various trademark patterns in FIG. 2.

d₁ indicates that a Pinyin syllable of each Chinese character in the trademark is segmented into one scorecard. That is, the Pinyin syllable of each Chinese character of the trademark is regarded as one scorecard. Taking FIG. 2h for example, pinyin syllables of “ [symbol] ” and “ [symbol] ” are “ge” and “li” respectively, and are respectively segmented into “ge” and “li” scorecards according to the trademark scorecard standard.

d₂ indicates that Pinyin syllables corresponding to the entire Chinese characters in the trademark are segmented into one scorecard. That is, the Pinyin syllables of the entire Chinese characters in the trademark are regarded as one scorecard. Taking FIG. 2h for example, pinyin syllables of “ [symbol] ” and “ [symbol] ” are “ge” and “li” respectively, and are respectively segmented into “geli” scorecard according to the trademark scorecard standard.

d₃ indicates that the Pinyin syllable of each Chinese character in the trademark after being replaced by a shape-approximate character is segmented into one scorecard. Taking FIG. 2h for example, the character “ [symbol] ” is replaced with a shape-approximate character “ [symbol] ”, the character “ [symbol] ” is replaced with a shape-approximate character “ [symbol] ”, and pinyin syllables of “ [symbol] ” are “ge” and “dao” respectively. It is segmented into “ge dao” scorecard according to the trademark scorecard standard.

E. A trademark scorecard standard consisting of multiple combination schemes of the sound feature minimum units the elements of which are letters, numerals and symbols, comprises: at least one of scorecard standards e₁, e₂, e₃ and e₄, wherein:

e₁ indicates that a sound syllable of each English word in the trademark is segmented into one scorecard,

e₂ indicates that an overall combination of letters acquired by replacing a combination of letters in the trademark by a combination of sound-approximate letters is segmented into one scorecard respectively,

e₃ indicates that a sound syllable of each numeral in the trademark is segmented into one scorecard, and

e₄ indicates that a sound syllable of each symbol in the trademark is segmented into one scorecard.

A processing method of the trademark scorecard rules will be described below with reference to various trademark patterns in FIG. 2.

e₁ indicates that a sound syllable of each English word in the trademark is segmented into one scorecard. That is, the sound syllable of each English word in the trademark is regarded as one scorecard. Taking FIG. 2i for example, sound syllables of the words “one”, “two” and “three” are “[w [symbol] n]”, “[tu:]” and “[θri:]” respectively, and are respectively segmented into“[w [symbol] n]”, “[tu:]” and “[θri:]” scorecards according to the trademark scorecard standard.

e₂ indicates that an overall combination of letters acquired by replacing a combination of letters in the trademark by a combination of sound-approximate letters is segmented into one scorecard respectively. That is, the trademark contains a combination of sound-approximate letters, and the combination of sound-approximate letters is regarded as one scorecard. Taking FIG. 2k for example, “CA” is the same as or similar to “KA” in sound, and segmented into “CATANA” and “KATANA” scorecards according to the trademark scorecard standard.

e₃ indicates that a sound syllable of each numeral in the trademark is segmented into one scorecard. That is, the sound syllable of each numeral of the trademark is regarded as one scorecard. Taking FIG. 2i for example, sound syllables of the English numerals “one”, “two” and “three” are [w [symbol] n]“, “[tu:]” and “[θri:]” respectively, and are respectively segmented into [w [symbol] n]“, “[tu:]” and “[θri:]” scorecards according to the trademark scorecard standard.

e₄ indicates that a sound syllable of each symbol in the trademark is segmented into one scorecard. That is, the trademark contains a symbol, and a sound of the symbol is regarded as one scorecard. Taking FIG. 2d for example, “@” is a symbol with a sound of “at” or “[ [symbol] t]”, and segmented into “at” or and ““[ [symbol] t]” scorecard according to the trademark scorecard standard.

F. A trademark scorecard standard consisting of multiple combination schemes of the sound feature minimum units the elements of which are graphs, comprises: a scorecard standard f₁, wherein f₁ indicates that a pinyin of a name of each thing corresponding to the trademark graph element code is segmented into one scorecard.

Taking FIG. 2n for example, the trademark graph element code acquired through retrieving is 5.7.13, and the name corresponding to the graph element codes for reflecting and describing each thing is “apple” or “persimmon”, the Pinyin of which is respectively “pingguo” or “shizi”, and is segmented into “pingguo” or “shizi” scorecard according to the trademark scorecard standard.

G. A trademark scorecard standard consisting of multiple combination schemes of the meaning feature minimum units the elements of which are Chinese characters, comprises: at least one of scorecard standards g₁, g₂, g₃ and g₄, wherein:

g₁ indicates that the trademark completely contains existing Chinese character trademarks in a trademark server, and the entire trademark is meaningless, and the part containing the existing Chinese character trademarks is segmented into one scorecard,

g₂ indicates that the vocabularies recorded in the Chinese dictionary or a combination of Chinese characters of the existing Chinese character trademarks in the trademark server are completely matched with the trademark, and the matching parts are segmented into one scorecard respectively,

g₃ indicates that Chinese vocabularies contained in the trademark after being replaced by synonyms are segmented into one scorecard respectively, and

g₄ indicates that the overall trademark is meaningless, and the overall Chinese characters are segmented into one scorecard.

A processing method of the trademark scorecard rules will be described below with reference to various trademark patterns in FIG. 2.

g₁ indicates that the trademark completely contains existing Chinese character trademarks in a trademark server, and the entire trademark is meaningless (the entire character cannot be matched with the vocabularies recorded in the Chinese dictionary), and the part containing the existing Chinese character trademarks is segmented into one scorecard. Unique meanings already consisting of the existing Chinese character trademarks can be regarded as a unique noun, and the noun is regarded as one scorecard. Taking FIG. 2d for example, the entire “ [symbol] ” is meaningless, assuming that “ [symbol] ” exists in the existing Chinese character trademark, it is segmented into “ [symbol] ” scorecard according to the trademark scorecard standard.

g₂ indicates that the vocabularies recorded in the Chinese dictionary or a combination of Chinese characters of the existing Chinese character trademarks in the trademark server are completely matched with the trademark, and the matching parts are segmented into one scorecard respectively. Taking FIG. 2g for example, it is segmented into “ [symbol] ” scorecard according to the trademark scorecard standard.

g₃ indicates that Chinese vocabularies contained in the trademark after being replaced by synonyms are segmented into one scorecard respectively. That is, the trademark contains a Chinese vocabulary, and a synonym of the vocabulary is regarded as one scorecard. Taking FIG. 2g for example, “ [symbol] ” (computer) and “ [symbol] ” (computer) are synonyms, and are respectively segmented into “ [symbol] ” scorecard according to the trademark scorecard standard.

g₄ indicates that the overall trademark is meaningless, and the overall Chinese characters are segmented into one scorecard. That is, the overall Chinese characters of the trademark are meaningless, and the overall Chinese characters of the trademark are regarded as one scorecard. Taking FIG. 2d for example, the entire Chinese characters of “ [symbol] [symbol] ” are meaningless, and are segmented into “ [symbol] ” scorecard according to the trademark scorecard standard.

H. A trademark scorecard standard consisting of multiple combination schemes of the meaning feature minimum units the elements of which are letters, numerals and symbol combinations, comprises: at least one of scorecard standards h₁, h₂, h₃, h₄, h₅, h₆, h₇, h₈ and h₉, wherein:

h₁ indicates that the overall combination of letters of the trademark is composed of a combination of words recorded in an English dictionary or dictionary in other languages, and the overall combination of words is segmented into one scorecard,

h₂ indicates that the trademark contains words recorded in the English dictionary or dictionary in other languages, and each word is segmented into one scorecard,

h₃ indicates that the trademark contains words recorded in the English dictionary or dictionary in other languages, and a synonym of each word is segmented into one scorecard,

h₄ indicates that the overall combination of letters of the trademark is not matched with the words recorded in the English dictionary or dictionary in other languages, and the overall combination of letters is segmented into one scorecard,

h₅ indicates that each group of numerals separated in the trademark is segmented into one scorecard,

h₆ indicates that the overall combination of numerals of the trademark is segmented into one scorecard,

h₇ indicates that the overall combination of symbols of the trademark is segmented into one scorecard,

h₈ indicates that each symbol of the trademark is segmented into one scorecard, and

h₉ indicates that the trademark completely contains a trademark of the existing combination of letters in the trademark server, and the entire trademark is meaningless, and a part containing the trademark of the existing combination of letters is segmented into one scorecard.

A processing method of the trademark scorecard standard will be described below with reference to various trademark patterns in FIG. 2.

h₁ indicates that the overall combination of letters of the trademark is composed of a combination of words recorded in an English dictionary or dictionary in other languages, and the overall combination of words is segmented into one scorecard. Taking FIG. 2i for example, the overall combination of letters of the trademark is composed of English words, and all the words are combined together and segmented into one scorecard, which is segmented into “one two three” scorecard according to the trademark scorecard standard.

h₂ indicates that the trademark contains words recorded in the English dictionary or dictionary in other languages, and each word is segmented into one scorecard. That is, the trademark contains English words, and each English word is respectively regarded as one scorecard. Taking FIG. 2i for example, it is respectively segmented into “one”, “two” and “three” scorecards according to the trademark scorecard standard.

h₃ indicates that the trademark contains words recorded in the English dictionary or dictionary in other languages, and a synonym of each word is segmented into one scorecard. That is, the trademark contains English synonyms, and the English synonyms are regarded as one scorecard. Taking FIG. 2j for example, the words “ability”, “capacity”, “capability”, “genius”, “talent”, “competence”, “faculty”, “gift” and “aptitude” all have the meaning of expressing “capability and talent” of a person, and are segmented into “ability”, “capacity”, “capability”, “genius”, “talent”, “competence”, “faculty”, “gift” and “aptitude” scorecards according to the trademark scorecard standard.

h₄ indicates that the overall combination of letters of the trademark is not matched with the words recorded in the English dictionary or dictionary in other languages, and the overall combination of letters is segmented into one scorecard. That is, the overall combination of letters of the trademark is not the words recorded in the English dictionary or dictionary in other languages. Taking FIG. 2a for example, “GREE” is not a word recorded in the English dictionary or dictionary in other languages, and is segmented into “GREE” scorecard according to the trademark scorecard standard.

h₅ indicates that each group of numerals separated in the trademark is segmented into one scorecard. That is, when the numerals in the trademark are separated into two or more groups of numerals, each group of numerals is segmented into one scorecard. The numerals being separated means that the numerals in the trademark are separated by characters, symbols, letters, pictures, spaces, and the like.

h₆ indicates that an overall combination of numerals of the trademark is segmented into one scorecard. That is, the overall combination of numerals contained in the trademark is combined and then segmented into one scorecard.

h₇ indicates that an overall combination of symbols of the trademark is segmented into one scorecard. That is, the overall combination of symbols contained in the trademark is combined and then segmented into one scorecard.

h₈ indicates that each symbol of the trademark is segmented into one scorecard. That is, each symbol contained in the trademark is segmented into one scorecard respectively.

h₉ indicates that the trademark completely contains a trademark of the existing combination of letters in the trademark server, and the entire trademark is meaningless, and a part containing the trademark of the existing combination of letters is segmented into one scorecard. That is, the trademark completely contains a trademark of the existing combination of letters in the trademark server, and the entire trademark is meaningless, and a part containing the trademark of the existing combination of letters is segmented into one scorecard. Taking FIG. 2a for example, it is supposed that the trademark completely contains the trademark of the existing combination of letters “GREE”, and “GREE” is not a word recorded in the English dictionary or dictionary in other languages, then the entire trademark is meaningless, and segmented into “GREE” scorecard according to the trademark scorecard standard.

I. A trademark scorecard standard consisting of multiple combination schemes of the meaning feature minimum units the elements of which are graphs, comprises: at least one of scorecard standards i₁ and i₂, wherein:

i₁ indicates that the name of each thing corresponding to the trademark graph element code is segmented into one scorecard, and

i₂ indicates that the trademark image feature descriptors correspond to the trademark graph element codes, and the name of each thing corresponding to the trademark graph element codes is segmented into one scorecard.

A processing method of the trademark scorecard standard will be described below with reference to various trademark patterns in FIG. 2.

i₁ indicates that the name of each thing corresponding to the trademark graph element code is segmented into one scorecard. The processing method is as follows: firstly, recording a correspondence between the trademark graph element code and the name of the thing described by the trademark graph element code by establishing a thing name dictionary file, and finding out the name of the thing matched with the thing dictionary file by using the graph element codes of the input trademarks as a retrieving condition, wherein the name of the thing is regarded as the name of the thing described by the trademark image feature descriptors, and the name of the thing is regarded as one scorecard. Taking FIG. 2n for example, the trademark graph element code acquired through retrieving is 5.7.13, the thing described by the trademark graph element code is “apple” and/or “persimmon”, the name “apple” and/or “persimmon” of the thing described by the graphs is regarded as one scorecard, and the name of each thing corresponding to the trademark graph element code “5.7.13” is respectively segmented into “apple” and “persimmon” scorecards according to the scorecard standard.

i₂ indicates that the trademark image feature descriptors correspond to the trademark graph element codes, and the name of each thing corresponding to the trademark graph element codes is segmented into one scorecard.

The trademark graph element codes corresponding to the trademark image feature descriptors, and the name of each thing corresponding to trademark graph element codes are acquired through the following method:

firstly, after acquiring one resultant trademark with the highest retrieving matching rate by using the trademark image feature descriptors of the input trademark as a retrieval keywork, a trademark graph element code of the resultant trademark marked by the prior art is regarded as the graph element code of the input trademark; then, recording a correspondence between the trademark graph element code and the name of the thing described by the trademark graph element code is recorded by establishing a thing dictionary file; and finally, finding out the name of the thing matched with the thing dictionary file by using the graph element code of the input trademark as a retrieval condition, wherein the name of the thing is regarded as the name of the thing described by the trademark image feature descriptor, and the name of the thing is regarded as one scorecard. Taking FIG. 2n for example, the trademark graph element code acquired by the trademark image feature descriptors (or trademark image feature information) through retrieving by is “5.7.13”, the corresponding “name of the thing” is “apple” and “persimmon”, then the trademark image feature descriptors are respectively segmented into “apple” and “persimmon” scorecards according to the scorecard standard.

Y. A trademark scorecard standard consisting of multiple combination schemes of minimum units the elements of which are exceptional adjustment characters, comprises: at least one of scorecard standards y₁ and y₂, wherein:

y₁ indicates that the trademark contains the exceptional adjustment characters, and the overall exceptional adjustment characters are segmented into one scorecard, and

y₂ indicates that the trademark contains the exceptional adjustment characters, and each character of the overall exceptional adjustment characters is segmented into one scorecard respectively.

The exceptional adjustment characters comprise more than one of the following preset characters: geographical names of administrative areas above the county level, foreign geographical names known to the public, generic names of commodities, vocabularies indicating quality, main materials, functions, uses, weights, quantities, and other characteristics of commodities, generic names of commodities and services, characters with weak significance.

Taking FIG. 2o for example, the “ [symbol] ” (Electric Appliances) in the trademark characters “ [symbol] ” are generic names of commodities, which are segmented into “ [symbol] ” (Electric Appliances) scorecard according to the scorecard standard y₁, and segmented into “ [symbol] ” (Electric) and “ [symbol] ” (Appliances) according to the scorecard standard y₂.

(2) Identify whether the sample trademark is composed of elements of Chinese characters, graphs, letters, numerals or symbols, and acquire contents of the elements.

For the contents of the elements of the trademark, Chinese characters comprise Chinese characters and combinations thereof contained in the trademark, graphs comprise pattern pictures of the trademarks and pixel information of the pictures, letters comprise letters and combinations thereof contained in the trademark, and numerals or symbols comprise Chinese numerals, Arabic numerals and numerals in other languages, or symbols contained in the trademark.

FIG. 2a to FIG. 2p show exemplary original drawings of trademarks which are given randomly, and these trademark images may possibly comprise the elements of the trademark like Chinese characters, letters, numerals, symbols, graphs, etc. The contents of the elements of the input trademarks are generally identified and acquired by being recorded at a retrieval portal for trademark retrieval, and can also be acquired by image recognition or OCR character identification. The contents of the elements of the sample trademarks are generally identified and acquired from various trademark name data records and trademark graph element code data records in the existing trademark database.

Taking FIG. 2a for example, the identified and acquired contents of the elements of the trademark are Chinese characters [symbol] , letters GREE, graph (the image of the trademark), and a trademark graph element code 26.1.10 (Note: identified and acquired from the marked information in the trademark database).

(3) Extract the shape feature minimum units, sound feature minimum units and meaning feature minimum units of various elements of the sample trademarks.

In the embodiment of the present invention, the purpose of the trademark scorecard is to provide data support for trademark similarity evaluation, the data consists of minimum unit data of various features and combinations thereof, and the minimum unit data and combination schemes thereof constitute a trademark scorecard standard, and the minimum unit data of various features comprise:

the shape feature minimum units comprising:

a shape feature minimum unit the elements of which are Chinese characters, which can be selected from one of the followings: each Chinese character, or each stroke of each Chinese character; taking FIG. 2a for example, the shape feature minimum unit of a trademark that is a Chinese character is: each Chinese character contained in the trademark, i.e., “ [symbol] ” and “ [symbol] ”;

a shape feature minimum unit the elements of which are graphs, which can be selected from one of the followings: a trademark graph element code, and a pixel set with a preset length on a trademark image contour line; taking FIG. 2a for example, the shape feature minimum unit of a trademark that is a graph is: a trademark graph element code, i.e.,“26.1.10”;

a shape feature minimum unit the elements of which are letters, which can be selected from one of the followings: words in each combination of letters, or each letter; taking FIG. 2a for example, the shape feature minimum units of the trademarks that are letters are: “GREE” when the words in each combination of letters are selected, or “G”, “R”, “E” and “E” when each letter is selected;

a shape feature minimum unit the elements of which are Chinese numerals, and selected from one of the followings: a combination of Chinese numerals, and each single Chinese numeral; taking FIG. 2b for example, the shape feature minimum units of the trademarks that are Chinese numerals are: “ [symbol] ” when the a combination of Chinese numerals is selected, and are “ [symbol] ”, “ [symbol] ” and “ [symbol] ” when each single Chinese numeral is selected;

a shape feature minimum unit the elements of which are Arabic numerals, and selected from one of the followings: a combination of Arabic numerals, and each single Arabic numeral;

a shape feature minimum unit the elements of which are numerals in other languages, and selected from one of the followings: a combination of numerals in other languages, and each single numeral in other languages; and

a shape feature minimum unit the elements of which are symbols: each signal symbol.

The meaning feature minimum units comprise:

a meaning feature minimum unit the elements of which are Chinese characters: when an overall combination of Chinese characters of a trademark is composed of a combination of vocabularies recorded in a Chinese dictionary, each vocabulary is the meaning feature minimum unit; otherwise, the overall combination of Chinese characters of the trademark is the meaning feature minimum unit;

a meaning feature minimum unit the elements of which are graphs: a name of each thing corresponding to the trademark graph element code;

a meaning feature minimum unit the elements of which are letters: when an overall combination of letters of the trademark is composed of a combination of words recorded in an English dictionary, or a combination of words recorded in a dictionary in other languages, each word is the meaning feature minimum unit; otherwise, the overall letter combination of the trademark is the meaning feature minimum unit;

a meaning feature minimum units the elements of which are Chinese numerals, and selected from one of the followings: numerals in a preset reference language corresponding to each group of Chinese numerals separated in the trademark, and numerals in a preset reference language corresponding to each single Chinese numeral in the trademark, wherein the numerals in the preset reference language are numerals in any languages;

a meaning feature minimum units the elements of which are Arabic numerals, and selected from one of the followings: numerals in a preset reference language corresponding to each group of Arabic numerals separated in the trademark, and numerals in a preset reference language corresponding to each single Arabic numeral in the trademark, wherein the numerals in the preset reference language are numerals in any languages;

a meaning feature minimum units the elements of which are numerals in other languages, and selected from one of the followings: numerals in a preset reference language corresponding to each group of numeral in other languages separated in the trademark, and numerals in a preset reference language corresponding to each single numeral in other languages in the trademark, wherein the numerals in the preset reference language are numerals in any languages; and

a meaning feature minimum units the elements of which are symbols: a symbolic name corresponding to each symbol in the trademark;

The sound feature minimum units comprise:

a sound feature minimum units the elements of which are Chinese characters: Pinyin of each Chinese character;

a sound feature minimum unit the elements of which are graphs: Pinyin of a name of each thing corresponding to the trademark graph element code;

a sound feature minimum units the elements of which are letters, and selected from one of the followings: a sound of each combination of letters, and a sound of each letter; and

a sound feature minimum units the elements of which are numerals or symbols, and selected from one of the followings: a sound of each group of numerals separated in the trademark, a sound of each single numeral, a sound of each group of symbols separated in the trademark, and a sound of each single symbol.

(4) According to the established trademark scorecard standard, extract segmentation information of various characters and graphs generated or converted by each combination scheme, use the segmentation information as sample trademark scorecard information, and set a similarity evaluation score for each predetermined preset trademark scorecard standard.

According to the forgoing established trademark scorecard standard, the contents of the elements of the sample trademarks such as Chinese characters, graphs, letters, numerals or symbols are acquired, the shape feature minimum unit, the sound feature minimum unit and the meaning feature minimum unit of the elements of the sample trademarks are extracted, the segmentation information of various characters and graphs generated or converted by the combination scheme of each minimum unit can be taken as the sample trademark scorecard information, and the preset similarity evaluation score of each preset trademark scorecard standard is established.

The preset similarity evaluation scores are as shown in Table 1, wherein t₁, t₂, t₃, t₄, . . . , t₅₆ respectively indicate the preset similarity evaluation scores corresponding to respective scorecard standard. In this embodiment, the preset similarity evaluation score of the preset trademark scorecard standard is determined by the personnel with certain professional experience in trademark examination for the influence of each trademark scorecard standard on the ranking of the trademark similarities, and a value ranges from 0.1% to 100%.

TABLE 1
Preset Similarity Evaluation Score of Each Scorecard Standard

| | | Preset |
|---|---|---|
| | | similarity |
| Scorecard | | evaluation |
| standard | Scorecard standard description | score |
| a₁ | An overall combination of characters in | t₁ |
| | all languages and graph element codes of | |
| | the trademark arranged in order is | |
| | segmented into one scorecard. | |
| a₂ | An overall combination of characters in | t₂ |
| | all languages and graph element codes of | |
| | the trademark arranged in a reversed | |
| | order is segmented into one scorecard. | |
| a₃ | Chinese characters in the trademark | t₃ |
| | arranged in order are segmented into | |
| | one scorecard | |
| a₄ | Chinese characters in the trademark | t₄ |
| | arranged in a reversed order are | |
| | segmented into one scorecard | |
| a₅ | Chinese numerals contained in the | t₅ |
| | trademark arranged in order are | |
| | segmented into one scorecard | |
| a₆ | Chinese numerals contained in the | t₆ |
| | trademark arranged in a reversed | |
| | order are segmented into one scorecard | |
| a₇ | Each relatively independent part in | t₇ |
| | the trademark is segmented into one | |
| | scorecard respectively | |
| a₈ | The trademark characters completely | t₈ |
| | contain the existing Chinese character | |
| | trademark, and the part is segmented | |
| | into one scorecard | |
| a₉ | Traditional and variant Chinese | t₉ |
| | characters contained in the trademark | |
| | are converted into simplified Chinese | |
| | characters and then segmented into | |
| | one scorecard | |
| a₁₀ | Each character in the trademark after | t₁₀ |
| | being replaced by a shape-approximate | |
| | character is segmented into one | |
| | scorecard | |
| a₁₁ | Every adjacent Chinese characters in | t₁₁ |
| | the trademark are segmented | |
| | into one scorecard respectively | |
| a₁₂ | A combination of first and last Chinese | t₁₂ |
| | characters in the trademark is segmented | |
| | into one scorecard | |
| a₁₃ | Each Chinese character in the trademark | t₁₃ |
| | is segmented into one scorecard | |
| b₁ | An overall combination of characters in | t₁₄ |
| | all languages and graph element codes of | |
| | the trademark arranged in order is | |
| | segmented into one scorecard | |
| b₂ | An overall combination of characters in | t₁₅ |
| | all languages and graph element codes of | |
| | the trademark arranged in a reversed | |
| | order is segmented into one scorecard | |
| b₃ | A combination of letters in the trademark | t₁₆ |
| | arranged in order is segmented into one | |
| | scorecard | |
| b₄ | A combination of letters in the trademark | t₁₇ |
| | arranged in a reversed order is segmented | |
| | into one scorecard | |
| b₅ | Non-Chinese numerals contained in the | t₁₈ |
| | trademark arranged in order or each single | |
| | non-Chinese numeral is segmented into one | |
| | scorecard respectively | |
| b₆ | Non-Chinese numerals contained in the | t₁₉ |
| | trademark arranged in a reversed order | |
| | or each single non-Chinese numeral is | |
| | segmented into one scorecard respectively | |
| b₇ | A combination of symbols contained in | t₂₀ |
| | the trademark arranged in order is | |
| | segmented into one scorecard | |
| b₈ | A combination of symbols contained | t₂₁ |
| | in the trademark arranged in a reversed | |
| | order is segmented into one scorecard | |
| b₉ | Each relatively independent part in the | t₂₂ |
| | trademark is segmented into one | |
| | scorecard respectively | |
| b₁₀ | Each letter in the trademark after | t₂₃ |
| | being replaced by a shape-approximate | |
| | letter is segmented into one scorecard | |
| b₁₁ | A combination of every adjacent | t₂₄ |
| | letters in the trademark is segmented | |
| | into one scorecard respectively | |
| b₁₂ | Letters in the trademark are arranged | t₂₅ |
| | in different orders, and then segmented | |
| | into one scorecard respectively | |
| b₁₃ | A combination of first and last letters | t₂₆ |
| | in the trademark is segmented into | |
| | one scorecard | |
| b₁₄ | Each letter, or numeral, or symbol in | t₂₇ |
| | the trademark is segmented into one | |
| | scorecard respectively | |
| c₁ | A trademark graph element code set is | t₂₈ |
| | entirely segmented into one scorecard | |
| c₂ | Each trademark graph element code is | t₂₉ |
| | segmented into one scorecard | |
| c₃ | An entirety of trademark image feature | t₃₀ |
| | descriptors generated by each image | |
| | feature recognition method is segmented | |
| | into one scorecard respectively | |
| c₄ | A preset length of the trademark image | t₃₁ |
| | feature descriptor generated by each | |
| | image feature recognition method is | |
| | segmented into one scorecard respectively | |
| d₁ | A Pinyin syllable of each Chinese | t₃₂ |
| | character in the trademark is | |
| | segmented into one scorecard | |
| d₂ | Pinyin syllables corresponding to | t₃₃ |
| | the overall Chinese characters in | |
| | the trademark are segmented into | |
| | one scorecard | |
| d₃ | The Pinyin syllable of each Chinese | t₃₄ |
| | character in the trademark after | |
| | being replaced by a shape-approximate | |
| | character is segmented into one scorecard | |
| e₁ | A sound syllable of each symbol in the | t₃₅ |
| | trademark is segmented into one scorecard | |
| e₂ | An overall combination of letters acquired | t₃₆ |
| | by replacing a combination of letters in | |
| | the trademark by a combination of sound- | |
| | approximate letters is segmented into | |
| | one scorecard respectively | |
| e₃ | A sound syllable of each numeral in the | t₃₇ |
| | trademark is segmented into one scorecard | |
| e₄ | A sound syllable of each symbol in the | t₃₈ |
| | trademark is segmented into one scorecard | |
| f₁ | A pinyin of a name of each thing corresponding | t₃₉ |
| | to the trademark graph element code is | |
| | segmented into one scorecard | |
| g₁ | The trademarks completely contain existing | t₄₀ |
| | Chinese character trademarks in a trademark | |
| | server, and the whole trademarks are | |
| | meaningless, and a part containing the | |
| | existing Chinese character trademarks is | |
| | segmented into one scorecard | |
| g₂ | The vocabularies recorded in the Chinese | t₄₁ |
| | dictionary or a combination of Chinese | |
| | characters of the existing Chinese character | |
| | trademarks in the trademark server are | |
| | completely matched with the trademark, | |
| | and the matching parts are segmented into | |
| | one scorecard respectively | |
| g₃ | Chinese vocabularies contained in the | t₄₂ |
| | trademark after being replaced by synonyms | |
| | are segmented into one scorecard respectively | |
| g₄ | The overall trademark is meaningless, | t₄₃ |
| | and the overall Chinese characters | |
| | are segmented into one scorecard | |
| h₁ | The overall letter combination of the | t₄₄ |
| | trademark is composed of a combination | |
| | of words recorded in an English dictionary | |
| | or dictionary in other languages, and | |
| | the overall combination of words is | |
| | segmented into one scorecard | |
| h₂ | The trademark contains words recorded | t₄₅ |
| | in the English dictionary or dictionary | |
| | in other languages, and each word is | |
| | segmented into one scorecard | |
| h₃ | The trademark contains words recorded | t₄₆ |
| | in the English dictionary or dictionary | |
| | in other languages, and a synonym of | |
| | each word is segmented into one scorecard | |
| h₄ | The overall combination of letters of the | t₄₇ |
| | trademark is not matched with the words | |
| | recorded in the English dictionary or | |
| | dictionary in other languages, and the | |
| | overall combination of letters is | |
| | segmented into one scorecard | |
| h₅ | Each group of numerals separated in the | t₄₈ |
| | trademark is segmented into one scorecard | |
| h₆ | The overall combination of numeral | t₄₉ |
| | of the trademark is segmented into | |
| | one scorecard | |
| h₇ | The overall combination of symbols of the | t₅₀ |
| | trademark is segmented into one scorecard | |
| h₈ | Each symbol of the trademark is segmented | t₅₁ |
| | into one scorecard | |
| h₉ | The trademark completely contains a | t₅₂ |
| | trademark of the existing combination | |
| | of letters in the trademark server, | |
| | and the entire trademark is meaningless, | |
| | and a part containing the trademark of | |
| | the existing combination of letters is | |
| | segmented into one scorecard | |
| i₁ | The name of each thing corresponding | t₅₃ |
| | to the trademark graph element code | |
| | is segmented into one scorecard | |
| i₂ | The trademark image feature descriptors | t₅₄ |
| | correspond to the trademark graph element | |
| | codes, and the name of each thing | |
| | corresponding to the trademark graph | |
| | element codes is segmented into one | |
| | scorecard | |
| y₁ | The trademark contains the exceptional | t₅₅ |
| | adjustment characters, and the overall | |
| | exceptional adjustment characters are | |
| | segmented into one scorecard | |
| y₂ | The trademark contains the exceptional | t₅₆ |
| | adjustment characters, and each character | |
| | of the overall exceptional adjustment | |
| | characters is segmented into one | |
| | scorecard respectively | |

According to the forgoing method, various trademark scorecard information are obtained, and the scorecard information is used as basic data for evaluating the trademark similarity in aspects of shape, sound and meaning, thus providing effective data support for solving the similarity evaluation between the resultant trademarks and the input trademarks for trademark retrieving.

Second, in the step S120, trademark scorecard processing is performed on input trademark images and contents according to preset trademark scorecard standards, wherein a specific processing procedure comprises: (1) establishing a trademark scorecard standard consisting of preset multiple combination schemes of shape feature minimum units, preset multiple combination schemes of sound feature minimum units, and preset multiple combination schemes of meaning feature minimum units, (2) identifying whether the input trademarks contain elements of Chinese characters, graphs, letters, numerals or symbols, and acquiring contents of the elements, (3) extracting a shape feature minimum unit, a sound feature minimum unit and a meaning feature minimum unit of each element of the input trademarks, and (4) according to the established trademark scorecard standard, extracting segmentation information of various characters and graphs generated or converted by each combination scheme, and using the segmentation information as input trademark scorecard information.

In the embodiment of the present invention, referring to the foregoing process of “performing trademark scorecard processing on the sample trademark images and contents according to the predetermined preset trademark scorecard standards”, the input trademarks are taken as processing objects, and segmentation information of various characters and graphs generated or converted by each combination scheme are extracted from the input trademarks.

The information is used as input trademark scorecard information.

The input trademark scorecard information comprises: a commodity category scope and a query content, the “query content” is the trademark scorecard information acquired from the input trademarks by trademark scorecard processing, comprising a scorecard type, a scorecard content, a number of scorecards, a scorecard standard adopted, a preset score value of the scorecard standard, etc. As a preferred embodiment, the input trademark scorecard information comprises: U₀, β₁, V₀, β₂, M₀ and Y₀, wherein U₀ indicates a number of scorecards of the input trademarks acquired on the basis of the trademark scorecard standards a₁₃, b₁₄, c₂, c₄ or a combination thereof; β₁ indicates a number of scorecards or a number of characters of the exceptional adjustment characters contained in the input trademarks and acquired on the basis of the scorecard standards a₁₃, b₁₄, c₂ and c₄; V₀ indicates a number of scorecards of the input trademarks acquired on the basis of the trademark scorecard standards d₁, d₂, d₃, e₁, e₂, e₃, e₄ or a combination thereof; β₂ indicates a number of scorecards or a number of syllables of the exceptional adjustment characters contained in the input trademarks and acquired on the basis of the scorecard standards d₁, d₂, d₃, e₁, e₂, e₃ and e₄; M₀ indicates a number of scorecards of the input trademarks after removing the exceptional adjustment characters matched with the scorecards of the resultant trademarks acquired on the basis of the trademark scorecard standards g₁, g₂, g₃ and g₄; and Y₀ indicates a number of scorecards of the input trademark acquired on the basis of the trademark scorecard standard y₁ or y₂.

Third, in the step S130, the sample trademark scorecard information stored in a trademark storage is retrieved by using an input trademark scorecard information set as a retrieval keywork, and scorecard information and scorecard matching information of relevant resultant trademarks are acquired.

In the embodiment, the input trademark scorecard information set as the retrieval keywork comprises the foregoing segmentation information of various characters and graphs that is used as trademark scorecard information that reflects the shape feature, the sound feature, and the meaning feature of the trademark.

The scorecard information and scorecard matching information of the resultant trademarks comprise: registration numbers of the resultant trademarks and commodity categories, scorecard types, scorecard contents, a number of scorecards, scorecard standards adopted, and preset score values of the scorecard standards, etc. In the embodiment, the scorecard information and scorecard matching information of the resultant trademarks comprise Yₐ, Uₐ, U_{b}, U_{c}, Vₐ, V_{b}, V_{c}, M₁, M₂, M₃, M₄, Jᵢ, n, kᵢ, r and Tᵢ, wherein Yₐ indicates a number of scorecards of the resultant trademarks acquired on the basis of the trademark scorecard standard y₁ or y₂; Uₐ indicates a number of scorecards of the resultant trademarks after removing the exceptional adjustment characters matched with the scorecards of the input trademarks acquired on the basis of the trademark scorecard standards a₁₃, b₁₄, c₂, c₄ or a combination thereof; U_{b} indicates a number of scorecards of the resultant trademarks after removing the exceptional adjustment characters matched with the scorecards of the input trademarks acquired on the basis of the trademark scorecard standards a₁₀, b₁₀ or a combination thereof; U_{c} indicates a number of places where mismatched scorecards are inserted between the matched scorecards of the resultant trademarks and the input trademarks acquired on the basis of the trademark scorecard standards a₁₃, b₁₄, c₂, c₄ or a combination thereof and the trademark scorecard standards a₁₀, b₁₀ or a combination thereof; Vₐ indicates a number of scorecards of the resultant trademarks after removing the exceptional adjustment characters matched with the scorecards of the input trademarks acquired on the basis of the trademark scorecard standards d₁, d₂, e₁, e₃, e₄ or a combination thereof; V_{b} indicates a number of scorecards of the resultant trademarks after removing the exceptional adjustment characters matched with the scorecards of the input trademarks acquired on the basis of the trademark scorecard standards d₃, e₂ or a combination thereof; V_{c} indicates a number of places where mismatched scorecards are inserted between the matched scorecards of the resultant trademarks and the input trademarks acquired on the basis of the trademark scorecard standards d₁, d₂, e₁, e₃, e₄ or a combination thereof and the trademark scorecard standards d₃, e₂ or a combination thereof; M₁ indicates a compared number of scorecards of the resultant trademarks after removing the exceptional adjustment characters matched with the input trademarks on the basis of the trademark scorecard standard g₁; M₂ indicates a compared number of scorecards of the resultant trademarks after removing the exceptional adjustment characters matched with the input trademarks on the basis of the trademark scorecard standard g₂; M₃ indicates a compared number of scorecards of the resultant trademarks after removing the exceptional adjustment characters matched with the input trademarks on the basis of the trademark scorecard standard g₃; M₄ indicates a compared number of scorecards of the resultant trademarks after removing the exceptional adjustment characters matched with the input trademarks on the basis of the trademark scorecard standard g₄; Jᵢ indicates a preset similarity evaluation score of the trademark scorecard standard corresponding to an i^{th} scorecard where the resultant trademarks are matched with the input trademarks; n indicates a number of scorecard items where the resultant trademarks are matched with the input trademarks; kᵢ indicates an average score of the preset similarity evaluation scores of the trademark scorecard standards corresponding to each scorecard where the resultant trademarks are matched with the input trademarks in an i^{th} feature type, r indicates a number of feature types of the resultant trademarks matched with the input trademarks; and Tᵢ indicates the highest score among the preset similarity evaluation scores of the trademark scorecard standards corresponding to each scorecard where the resultant trademarks are matched with the input trademarks in the i^{th} feature type.

Fourth, in the step S140, according to preset calculation formulas for a trademark shape similarity, a trademark meaning similarity, a trademark sound similarity and a scoring rate of retrieval keywork matching, a trademark shape similarity, a trademark meaning similarity, a trademark sound similarity and a scoring rate of retrieval keywork matching between the input trademarks and the resultant trademarks are respectively calculated.

The calculation formula and a calculation method are described as follows in combination with specific embodiments:

(1) the calculation formula for a trademark shape similarity is:

Wᵤₙᵢₜ=Uₐ/(U₀−β₁)+[U_{b}/(U₀−β₁)]×λ₁−[U_{c}/(U₀−β₁)]×λ₂

wherein, Wᵤₙᵢₜ indicates the trademark shape similarity, U₀ indicates a number of scorecards of the input trademarks acquired on the basis of the trademark scorecard standards a₁₃, b₁₄, c₂, c₄ or a combination thereof; Uₐ indicates a number of scorecards of the resultant trademarks after removing the exceptional adjustment characters matched with the scorecards of the input trademarks acquired on the basis of the trademark scorecard standards a₁₃, b₁₄, c₂, c₄ or a combination thereof; U_{b} indicates a number of scorecards of the resultant trademarks after removing the exceptional adjustment characters matched with the scorecards of the input trademarks acquired on the basis of the trademark scorecard standards a₁₀, b₁₀ or a combination thereof; U_{c} indicates a number of places where mismatched scorecards are inserted between the matched scorecards of the resultant trademarks and the input trademarks acquired on the basis of the trademark scorecard standards a₁₃, b₁₄, c₂, c₄ or a combination thereof and the trademark scorecard standards a₁₀, b₁₀ or a combination thereof; (31 indicates a number of scorecards or a number of characters of the exceptional adjustment characters contained in the input trademarks and acquired on the basis of the scorecard standards a₁₃, b₁₄, c₂, c₄; and λ₁ and λ₂ are preset adjustment weights both ranging from 10% to 300%;

For example, the input trademark is “ [symbol] ” as shown in FIG. 2h. A scorecard collection of various feature types of the input trademarks comprise “ [symbol] ”, “ [symbol] ”, “ [symbol] ”, “ [symbol] ”, “ [symbol] ”, “ [symbol] ” and “ [symbol] ”, which are used as retrieval keyworks to retrieval the trademark database, and the relevant query resultant trademarks are “ [symbol] ”, “ [symbol] ” and “ [symbol] ”. Moreover, it is assumed that the value of λ₁ is 90%, the value of λ₂ is 150%, none of the input trademarks and the resultant trademarks contain the trademark exceptional adjustment characters, and β₁ is 0. Then the shape similarities between the resultant trademarks and the input trademarks are calculated according to the calculation formula for a trademark shape similarity:

1) The trademark shape similarity between the input trademark “ [symbol] ” and the resultant trademark “ [symbol] ” is:

Wᵤₙᵢₜ=Uₐ/(U₀−β₁)+[U_{b}/(U₀−β₁)]×λ₁−[U_{c}/(U₀−β₁)]×λ₂=2/(2−0)+[0/(2−0)]×90%−[0/(2−0)]×150%=1=100%.

2) The trademark shape similarity between the input trademark “ [symbol] ” and the resultant trademark “ [symbol] ” is:

Wᵤₙᵢₜ=Uₐ/(U₀−β₁)+[U_{b}/(U₀−β₁)]×λ₁−[U_{c}/(U₀−β₁)]×λ₂=1/(2−0)+[1/(2−0)]×90%−[0/(2−0)]×150%=95%.

3) The trademark shape similarity between the input trademark “ [symbol] ” and the resultant trademark “ [symbol] ” is:

Wᵤₙᵢₜ=Uₐ/(U₀−β₁)+[U_{b}/(U₀−β₁)]×λ₁−[U_{c}/(U₀−β₁)]×λ₂=0/(2−0)+[2/(2−0)]×90%−[0/(2−0)]×150%=90%.

(2) The calculation formula for a trademark sound similarity is:

S_{sound}=Vₐ/(V₀−β₂)+[V_{b}/(V₀−β₂)]×μ₁−[V_{c}/(V₀−β₂)]×μ₂,

wherein, S_{sound} indicates the trademark sound similarity; V₀ indicates a number of scorecards of the input trademarks acquired on the basis of the trademark scorecard standards d₁, d₂, d₃, e₁, e₂, e₃, e₄ or a combination thereof; Vₐ indicates a number of scorecards of the resultant trademarks after removing the exceptional adjustment characters matched with the scorecards of the input trademarks acquired on the basis of the trademark scorecard standards d₁, d₂, e₁, e₃, e₄ or a combination thereof; V_{b} indicates a number of scorecards of the resultant trademarks after removing the exceptional adjustment characters matched with the scorecards of the input trademarks acquired on the basis of the trademark scorecard standards d₃, e₂ or a combination thereof; V_{c} indicates a number of places where mismatched scorecards are inserted between the matched scorecards of the resultant trademarks and the input trademarks acquired on the basis of the trademark scorecard standards d₁, d₂, e₁, e₃, e₄ or a combination thereof and the trademark scorecard standards d₃, e₂ or a combination thereof; (32 indicates a number of scorecards or a number of syllables of the exceptional adjustment characters contained in the input trademarks and acquired on the basis of the scorecard standards d₁, d₂, d₃, e₁, e₂, e₃ and e₄; μ₁ and μ₂ are preset adjustment weights both ranging from 10% to 300%.

For example, the input trademark is “ [symbol] ” as shown in FIG. 2h. A scorecard collection of various feature types of the input trademarks is used as retrieval keyworks to retrieval the trademark database, and the acquired relevant query resultant trademarks are “ [symbol] [symbol] ”, “ [symbol] ” and “ [symbol] ”, and syllables of corresponding characters thereof are respectively “ge”, “li” and “dao”. Moreover, it is assumed that the value of μ₁ is 90%, the value of μ₂ is 150%, none of the input trademarks and the resultant trademarks contain the trademark exceptional adjustment characters, and β₂ is 0. Then the sound similarities between the resultant trademarks and the input trademark are calculated according to the calculation formula for a trademark sound similarity:

1) The trademark sound similarity between the input trademark “ [symbol] ” (“ge”, “li”) and the resultant trademark “ [symbol] ” (“ge”, “li”) is:

S_{sound}=Vₐ/(V₀−β₂)+[V_{b}/(V₀−β₂)]×μ₁−[V_{c}/(V₀−β₂)]×μ₂=2/(2−0)+[0(2−0)]×90%−[0/(2−0)]×150%=100%.

2) The trademark sound similarity between the input trademark “ [symbol] ” (“ge”, “li”) and the resultant trademark “ [symbol] ” (“ge”, “dao”) is:

S_{sound}=Vₐ/(V₀−β₂)+[V_{b}/(V₀−β₂)]×μ₁−[V_{c}/(V₀−β₂)]×μ₂=1/(2−0)+[0/(2−0)]×90%−[0/(2−0)]×150%=50%.

3) The trademark sound similarity between the input trademark “ [symbol] ” (“ge”, “li”) and the resultant trademark “ [symbol] ” (“ge”, “li”) is:

S_{sound}=Vₐ/(V₀−β₂)+[V_{b}/(V₀−β₂)]×μ₁−[V_{c}/(V₀−β₂)]×μ₂=0/(2−0)+[2/(2−0)]×90%−[0/(2−0)]×150%=90%.

(3) The calculation formula for a trademark meaning similarity is:

S_{meaning}=(M₁+M₂×α₁+M₃×α₂+M₄×α₃)/(M₀)−θ,

wherein, S_{meaning} indicates the trademark meaning similarity; M M₀ indicates a number of scorecards of the input trademarks after removing the exceptional adjustment characters matched with the scorecards of the resultant trademarks acquired on the basis of the trademark scorecard standards g₁, g₂, g₃ and g₄; M₁ indicates a compared number of scorecards of the resultant trademarks after removing the exceptional adjustment characters matched with the input trademarks on the basis of the trademark scorecard standard g₁; M₂ indicates a compared number of scorecards of the resultant trademarks after removing the exceptional adjustment characters matched with the input trademarks on the basis of the trademark scorecard standard g₂, M₃ indicates a compared number of scorecards of the resultant trademarks after removing the exceptional adjustment characters matched with the input trademarks on the basis of the trademark scorecard standard g₃; M₄ indicates a compared number of scorecards of the resultant trademarks after removing the exceptional adjustment characters matched with the input trademarks on the basis of the trademark scorecard standard g₄; α₁, α₂ and α₃ respectively indicate adjustment parameters for M₂, M₃ and M₄, and value rules are as follows: when two or more parameters of M₁, M₂, M₃ and M₄ are not 0 at the same time, the first parameter in M₁, M₂, M₃ and M₄ is a valid parameter, and the rest are invalid parameters, and when M₁ is not 0, α₁, α₂ and α₃ are 0; when M₁ is 0 and M₂ is not 0, α₁, α₂ and α₃ are 0; when M₁ and M₂ are 0, and M₃ is not 0, a₂ is 1, and α₃ is 0; when M₁, M₂ and M₃ are 0, and M₄ is not 0, α₃ is 1; and θ indicates an adjustment parameter adjustment with different number of trademark characters between the input trademarks and the compared resultant trademarks, ranging from 1% to 90%.

For example, the input trademark is “ [symbol] ” as shown in FIG. 2c. It is assumed that a scorecard collection of various feature types of the input trademarks is used as retrieval keyworks to retrieval the trademark database, the trademark storage is stored with data of the prior trademarks “ [symbol] ” and “ [symbol] ”, the acquired relevant query resultant trademarks are “ [symbol] ” and “ [symbol] ”. It is assumed that the value of θ is 10%, the meaning similarities between the resultant trademarks and the input trademark are calculated according to the calculation formula for a trademark meaning similarity:

1) The trademark meaning similarity between the input trademark “ [symbol] ” and the resultant trademark “ [symbol] ” is:

There are no “exceptional adjustment characters” in the input trademark, a number of scorecards of the input trademark “ [symbol] ” and the resultant trademark “ [symbol] ” based on the trademark scorecard standard g₁ is 1, M₀ and M₁ are both 1, the input trademark “ [symbol] [symbol] ” is not applicable to the trademark scorecard standards g₂, g₃ and g₄, M₂, M₃ and M₄ are 0, a number of scorecards of the input trademark “ [symbol] ” and the compared resultant trademark “ [symbol] ” based on the trademark scorecard standard g₄ is 1, and M₄ is 1. It is assumed that the value of θ is 10%, and then a calculation result is as follows:

S_{meaning}=[(M₁+M₂×α₁+M₃×α₂+M₄×α₃)/M₀]−θ=[(1+0+0+1×0)/1]−10%=90%.

2) The trademark meaning similarity between the input trademark “ [symbol] ” and the compared resultant trademark “ [symbol] ”:

There are no “exceptional adjustment characters” in the input trademark, a number of scorecards of the input trademark “ [symbol] ” and the compared resultant trademark “ [symbol] ” based on the trademark scorecard standard g₁ is 1, M₀ and M₁ are both 1, the input trademark “ [symbol] ” is not applicable to the trademark scorecard standards g₂, g₃ and g₄, M₂, M₃ and M₄ are 0, a number of scorecards of the input trademark “ [symbol] ” and the compared resultant trademark “ [symbol] ” based on the trademark scorecard standard g₄ is 1, and M₄ is 1. It is assumed that the value of θ is 10%, and then a calculation result is as follows:

S_{meaning}=[(M₁+M₂×α₁+M₃×α₂+M₄×α₃)/M₀]−θ=[(1+0+0+1×0)/1]−10%=90%.

For example, the input trademark is “ [symbol] ” as shown in FIG. 2o. It is assumed that a scorecard collection of various feature types of the input trademarks is used as retrieval keyworks to retrieval the trademark database, the trademark storage is stored with data of the prior trademark “ [symbol] ”, the acquired relevant query resultant trademark is “ [symbol] ”. It is assumed that the value of θ is 10%, and a process for calculating the meaning similarities between the resultant trademark and the input trademark according to the calculation formula for a trademark meaning similarity is as follows:

the “ [symbol] ” (Electric Appliances) in the input trademark is a “generic name of commodities and services”, which belongs to “exceptional adjustment characters”, and should be removed when calculating;

A number of scorecards of the input trademark “ [symbol] ” and the compared resultant trademark “ [symbol] ” based on the trademark scorecard standard g₁ is 1, M₀ and M₁ are both 1, the input trademark “ [symbol] ” is not applicable to the trademark scorecard standards g₂ and g₃, M₂ and M₃ are both 0, a number of scorecards of the input trademark “ [symbol] [symbol] ” and the compared resultant trademark “ [symbol] ” based on the trademark scorecard standard g₄ is 1, and M₄ is 1. The value of θ is 10%, then a calculation result is as follows:

S_{meaning}=[(M₁+M₂×α₁+M₃×α₂+M₄×α₃)/M₀]−θ=[(1+0+0+1×0)/1]−10%=90%.

(4) the calculation formula for a scoring rate of retrieval keywork matching comprises at least one of the followings: a comprehensive average scoring rate of retrieval keywork matching, an average scoring rate of retrieval keywork matching classification, a highest scoring rate of retrieval keywork matching classification, and a highest weighted scoring rate of retrieval keywork matching classification, namely: S_{keywork}=S₁, or S_{keywork}=S₂, S_{keywork}=S₃, or S_{keywork}=S₄

wherein, S_{keywork} indicates the scoring rate of retrieval keywork matching, S₁ indicates the comprehensive average scoring rate of retrieval keywork matching, S₂ indicates the average scoring rate of retrieval keywork matching classification, S₃ indicates the highest scoring rate of retrieval keywork matching classification, and S₄ indicates the highest weighted scoring rate of retrieval keywork matching classification.

The calculation formula for a scoring rate of various retrieval keywork matching is as follows:

A calculation formula for the comprehensive average scoring rate of retrieval keywork matching S₁ is:

S₁=(J₁+J₂+J₃+ . . . +Jₙ)÷n

wherein, S₁ indicates the comprehensive average scoring rate of retrieval keywork matching, and J₁, J₂, J₃, . . . , Jₙ respectively indicate the preset similarity evaluation score of the trademark scorecard standard corresponding to each scorecard of the resultant trademark matched with the input trademark, and n indicates a number of scorecards of the resultant trademark matched with the input trademark.

2) A calculation formula for the average scoring rate of retrieval keywork matching classification S₂ is:

S₂=(k₁+k₂+k₃+ . . . +kᵣ)÷r

wherein, S₂ indicates the average scoring rate of retrieval keywork matching classification, k₁ indicates the average score of the preset similarity evaluation scores of the trademark scorecard standards corresponding to each scorecard where the resultant trademarks are matched with the input trademarks in a first feature type, k₂ indicates the average score of the preset similarity evaluation scores of the trademark scorecard standards corresponding to each scorecard where the resultant trademarks are matched with the input trademarks in a second feature type, k₃ indicates the average score of the preset similarity evaluation scores of the trademark scorecard standards corresponding to each scorecard where the resultant trademarks are matched with the input trademarks in a third feature type, kᵣ indicates the average score of the preset similarity evaluation scores of the trademark scorecard standards corresponding to each scorecard where the resultant trademarks are matched with the input trademarks in an r^{th} feature type, and r indicates a number of matched feature types.

3) A calculation formula for the highest scoring rate of retrieval keywork matching classification S₃ is:

S₃=(T₁+T₂+T₃+ . . . +Tᵣ)÷r

wherein, S₃ indicates the highest scoring rate of retrieval keywork matching classification, T₁ indicates the highest score among the preset similarity evaluation scores of the trademark scorecard standards corresponding to each scorecard where the resultant trademarks are matched with the input trademarks in the first feature type, T₂ indicates the highest score among the preset similarity evaluation scores of the trademark scorecard standards corresponding to each scorecard where the resultant trademarks are matched with the input trademarks in the second feature type, T₃ indicates the highest score among the preset similarity evaluation scores of the trademark scorecard standards corresponding to each scorecard where the resultant trademarks are matched with the input trademarks in the third feature type, Tᵣ indicates the highest score among the preset similarity evaluation scores of the trademark scorecard standards corresponding to each scorecard where the resultant trademarks are matched with the input trademarks in the r^{th} feature type, r indicates a number of matched feature types.

4) A calculation formula for the highest weighted scoring rate of retrieval keywork matching classification S₄ is:

S₄=T₁×ω₁+T₂×ω₂+T₃×ω₃+ . . . +Tᵣ×ωᵣ

wherein, S₄ indicates the highest weighted scoring rate of retrieval keywork matching classification, T₁ indicates the highest score among the preset similarity evaluation scores of the trademark scorecard standards corresponding to each scorecard where the resultant trademarks are matched with the input trademarks in the first feature type, T₂ indicates the highest score among the preset similarity evaluation scores of the trademark scorecard standards corresponding to each scorecard where the resultant trademarks are matched with the input trademarks in the second feature type, T₃ indicates the highest score among the preset similarity evaluation scores of the trademark scorecard standards corresponding to each scorecard where the resultant trademarks are matched with the input trademarks in the third feature type, Tᵣ indicates the highest score among the preset similarity evaluation scores of the trademark scorecard standards corresponding to each scorecard where the resultant trademarks are matched with the input trademarks in the r^{th} feature type, r indicates a number of matched feature types, ω₁, ω₂, ω₃, . . . , and ωᵣ respectively indicate calculation weights of highest scores in the preset similarity evaluation scores of the trademark scorecard standards corresponding to the scorecards where the resultant trademarks are matched with the input trademarks in the first feature type, the second feature type, the third feature type, . . . , and the r^{th} feature type, and ω₁, ω₂, ω₃, . . . , and ωᵣ range from 1% to 80%, and the total of all the calculation weights is 100%.

In some embodiments, the feature type, according to the aspects of shape, meaning and sound comprises: a shape feature type (T₁), a sound feature type (T₂), and a meaning feature type (T₃); and, according to the contents of the elements, comprises: a Chinese character feature type (T₁), a letter character feature type (T₂), a numeral character feature type (T₃), a symbol character feature type (T₄), a graph element code graph feature type (T₅), and an image feature descriptor graph feature type (T₆).

For example, the input trademark is the “ [symbol] ” as shown in FIG. 2d. A scorecard collection of various feature types of the input trademark is used as retrieval keyworks to retrieval the trademark database, and the acquired relevant query resultant trademarks are “ [symbol] ” and “ [symbol] ”. The scorecards matched with the retrieval keyworks comprise the scorecards acquired by segmenting according to the trademark scorecard standards a₁₁, a₁₂, a₁₃, e₁ and g₁. Moreover, it is assumed that the preset similarity evaluation scores of the trademark scorecard standards a₁₁, a₁₂, a₁₃, e₁, g₁ and j₁ are respectively 50%, 60%, 40%, 40% and 100%, then calculation weights of the shape feature type (T₁), the sound feature type (T₂) and the meaning feature type (T₃) are as follows: ω₁=50%, ω₂=20% and ω₃=30%. According to the calculation formula for a scoring rate of retrieval keywork matching according to the embodiment is as follows:

1) The comprehensive average scoring rate of retrieval keywork matching is:

S₁=(J₁+J₂+J₃+ . . . +Jₙ)÷n=(50%+60%+40%+40%+100%)÷5=58%.

2) The average scoring rate of retrieval keywork matching classification is:

When the trademark scorecards are divided according to the aspects of shape, sound and meaning, the feature type comprises three feature types, i.e., the shape feature type, the sound feature type, and the meaning feature type. In this embodiment, the scorecards acquired according to the trademark scorecard standards a₁₁, a₁₂, and an belong to the shape feature type, the scorecards acquired according to the trademark scorecard standard e₁ belong to the sound feature type, and the scorecards acquired according to the trademark scorecard standard g₁ belong to the meaning feature type, and the number of matched feature types r is 3.

The average scoring rate of retrieval keywork matching classification is:

S₂=(k₁+k₂+k₃+ . . . +kᵣ)÷r, wherein

r=3,

k₁=(50%+60%+40%)÷3=50%,

K₂=40%÷1=40%,

K₃=100%÷1=100%,

so, S₂=(50%+40%+100%)÷3=63.33%.

3) Highest scoring rate of retrieval keywork matching classification

In this embodiment, the trademark scorecard standard with highest score in the shape feature type of the retrieval keywork is the trademark scorecard standard a₁₂, with a score of 60%, the trademark scorecard standard with highest score in the sound feature type of the retrieval keywork is the trademark scorecard standard e₁, with a score of 40%, and the trademark scorecard standard with highest score in the meaning feature type of the retrieval keywork is the trademark scorecard standard g₁, with a score of 100%, and the number of matched feature types r is 3.

The highest scoring rate of retrieval keywork matching classification is:

S₃=(T₁+T₂+T₃+ . . . +Tᵣ)÷r, wherein,

r=3

T₁=60%

T₂=40%

T₃=100%.

So, S₃=(60%+40%+100%)÷3=66.67%.

4) The highest weighted scoring rate of retrieval keywork matching classification

a calculation formula is:

S₄=T₁×ω₁+T₂×ω₂+T₃×ω₃+ . . . +Tᵣ×ωᵣ=60%×50%+40%×20%+100%×30%=30%+8%+30%=68%.

Fifth, in the step S150, according to a preset calculation formula for comprehensive quantified values of trademark similarity, comprehensive quantified values of trademark similarity is acquired by calculation, and the resultant trademarks are sorted according to magnitudes of the comprehensive quantified values of trademark similarity.

In this embodiment, the comprehensive quantified values of trademark similarity are calculated by a following formula:

TMₙₑₐᵣ=Wᵤₙᵢₜ×Q₁+S_{sound}×Q₂+S_{meaning}×Q₃+S_{keywork}×Q₄

wherein, TMₙₑₐᵣ indicates the comprehensive quantified values of trademark similarity, Wᵤₙᵢₜ indicates the trademark shape similarity, S_{sound} indicates the trademark sound similarity, S_{meaning} indicates the trademark meaning similarity, S_{keywork} indicates the scoring rate of retrieval keywork matching, Q₁, Q₂, Q₃ and Q₄ respectively indicate weights of the trademark shape similarity, the trademark sound similarity, the trademark meaning similarity and the scoring rate of retrieval keywork matching, Q₁, Q₂, Q₃ and Q₄ range from 5% to 95%, and the total of all the calculation weights is 100%.

The following describes the calculation method of the comprehensive quantified values of trademark similarity in combination with some specific examples of the original drawings of the trademarks.

Assuming that the input trademark is “ [symbol] ” as shown in FIG. 2o, and the acquired resultant trademarks are “ [symbol] ” and “ [symbol] ”, wherein the “ [symbol] ” (Electric Appliances) of the input trademark are “generic names of commodities and services” and belong to the trademark exceptional adjustment characters. The scorecards matched with the retrieval keywork and acquired through calculation comprise the scorecards segmented according to the scorecard standards a₈, a₁₂, a₁₃, d₂, e₁ and g₁. Moreover, the preset similarity evaluation scores corresponding to a₈, a₁₂, a₁₃, d₂, e₁ and g₁ are respectively set to be 90%, 50%, 60%, 40%, 60%, 40% and 100%, the value of λ₁ is 90%, the value of λ₂ is 80%, the value of μ₁ is 90%, and the value of μ₂ is 80%, wherein, the weight values of the preset trademark shape similarity, the preset trademark sound similarity, the preset trademark meaning similarity and the preset scoring rate of retrieval keywork matching are 40%, 15%, 30% and 15% respectively. In this embodiment, the trademark scorecards are divided according to shape, sound and meaning, and the feature types comprise three feature types: a shape feature type, a sound feature type and a meaning feature type. Taking the highest scoring rate of retrieval keywork matching classification as the scoring rate of retrieval keywork matching, the “Electric appliances” are “generic names of commodities and services” and belong to the trademark exceptional adjustment parameter. The calculation process and results of the comprehensive quantified values of trademark similarity are as follows:

1. The input trademark “ [symbol] ” and the resultant trademark “ [symbol] ”

Firstly, a trademark shape similarity, a trademark sound similarity, a trademark meaning similarity and a scoring rate of retrieval keywork matching between the input trademark “GREE Electric Appliances” and the resultant trademark:

1) A calculation result of the trademark shape similarity is:

Wᵤₙᵢₜ=Uₐ/(U₀−β₁)+[U_{b}/(U₀−β₁)]×λ₁−[U_{c}/(U₀−β₁)]×λ₂=2/(2−0)+0/(2−0)×90%−0/(2−0)×80%=100%.

2) A calculation result of the trademark sound similarity is:

The sounds of the trademark “ [symbol] ” are “ge”, “li”, “dian”, “qi”, and the sounds of the resultant trademark “ [symbol] ” are “ge”, “li”.

S_{sound}=Vₐ/(V₀−β₂)+[V_{b}/(V₀−β₂)]×μ₁−[V_{c}/(V₀−β₂)]×μ₂=2/(2−0)+0/(2−0)×90%−0/(2−0)×80%=100%.

3) A calculation result of the trademark meaning similarity is:

The “ [symbol] ” (Electric Appliances) belong to exceptional adjustment characters. The input trademark “ [symbol] ” after removing the exceptional adjustment characters is “ [symbol] ”. The “ [symbol] ” of the input trademark “ [symbol] ” after removing the exceptional adjustment characters is matched with the compared resultant trademark “ [symbol] ”, and belongs to a scorecard of the input trademark after removing the exceptional adjustment characters matched with the resultant trademark on the basis of the trademark scorecard standard g₁. M₀ and M₁ are both 1. In the embodiment, M₂ and M₃ are both 0, “ [symbol] ” is not recorded in a Chinese dictionary, and belongs to a meaningless combination; therefore, M₄ is 1. The number of characters of the input trademark is different from that of the resultant trademark, confirming an adjustment parameter feature of θ, and θ is 10%, then:

S_{meaning}=[(M₁+M₂×α₁+M₃×α₂+M₄×α₃)/M₀]−θ=[(1+0+0+1×0)/1]−10%=90%.

4) scoring rate of retrieval keywork matching: the calculation process of the highest scoring rate of retrieval keywork matching classification in this embodiment is as follows:

The trademark scorecard standard with highest score Tᵢ in the shape feature type of the retrieval keywork is the trademark scorecard standard a₈, with a score of 90%, the trademark scorecard standard with highest score T₂ in the sound feature type of the retrieval keywork is the trademark scorecard standard e₁, with a score of 40%, and the trademark scorecard standard with highest score T₃ in the meaning feature type of the retrieval keywork is the trademark scorecard standard g₁, with a score of 100%, and the number of matched feature types r is 3.

So, S_{keywork}=(T₁+T₂+T₃+ . . . Tᵣ)÷r=(90%+40%+100%)÷3=76.67%.

Then, comprehensive quantified values of trademark similarity are calculated according to the trademark shape similarity, the trademark sound similarity, the trademark meaning similarity and the scoring rate of retrieval keywork matching between the input trademark “GREE Electric Appliances” and the resultant trademark:

TMₙₑₐᵣ=Wᵤₙᵢₜ×Q₁+S_{sound}×Q₂+S_{meaning}×Q₃+S_{keywork}×Q₄=100%×40%+100%×15%+90%×30%+76.67%×15%=40%+15%+27%+11.5%=93.5%.

2. The input trademark “ [symbol] ” and the resultant trademark “ [symbol] ”

Firstly, a trademark shape similarity, a trademark sound similarity, a trademark meaning similarity and a scoring rate of retrieval keywork matching between the input trademark “ [symbol] ” and the resultant trademark:

1) A calculation result of the trademark shape similarity is:

Wᵤₙᵢₜ=Uₐ/(U₀−β₁)+[U_{b}/(U₀−β₁)]×λ₁−[U_{c}/(U₀−β₁)]×λ₂=0/(2−0)+2/(2−0)×90%−0/(2−0)×80%=90%.

2) A calculation result of the trademark sound similarity is:

The sounds of the trademark “ [symbol] ” are “ge”, “li”, “dian”, “qi”, and the sounds of the resultant trademark “ [symbol] ” are “ge”, “li”.

S_{sound}=Vₐ/(V₀−β₂)+[V_{b}/(V₀−β₂)]×μ₁−[V_{c}/(V₀−β₂)]×μ₂=0/(2−0)+[2/(2−0)]×90%−[0/(2−0)]×80%=90%.

3) A calculation result of the trademark meaning similarity is:

The “ [symbol] ” (Electric Appliances) belong to exceptional adjustment characters. The input trademark “ [symbol] ” after removing the exceptional adjustment characters is “ [symbol] ”. The “ [symbol] ” of the input trademark “ [symbol] ” after removing the exceptional adjustment characters is matched with the compared resultant trademark “ [symbol] ”, and belongs to a scorecard of the input trademark after removing the exceptional adjustment characters matched with the resultant trademark on the basis of the scorecard standard g₂. M₀ and M₂ are both 1. The number of scorecards of M₁ and M₃ are both 0, “ [symbol] ” is not recorded in a Chinese dictionary, and belongs to a meaningless combination; therefore, M₄ is 1. The number of characters of the input trademark is different from that of the resultant trademark, confirming an adjustment parameter feature of θ, and θ is 10%, then:

S_{meaning}=[(M₁+M₂×α₁+M₃×α₂+M₄×α₃)/M₀]−θ=[(0+1×1+0+1×0)/1]−10%=90%.

4) scoring rate of retrieval keywork matching: the calculation process of the highest scoring rate of retrieval keywork matching classification in this embodiment is as follows:

The trademark scorecard standard with highest score T₁ in the shape feature type of the retrieval keywork is the trademark scorecard standard a₈, with a score of 90%, the trademark scorecard standard with highest score T₂ in the sound feature type of the retrieval keywork is the trademark scorecard standard e₁, with a score of 40%, and the trademark scorecard standard with highest score T₃ in the meaning feature type of the retrieval keywork is the trademark scorecard standard g₁, with a score of 100%, and the number of matched feature types r is 3.

So, S_{keywork}=(T₁+T₂+T₃+ . . . Tᵣ)÷r=(90%+40%+100%)±3=76.67%.

Then, comprehensive quantified values of trademark similarity are calculated according to the trademark shape similarity, the trademark sound similarity, the trademark meaning similarity and the scoring rate of retrieval keywork matching between the input trademark “GREE Electric Appliances” and the resultant trademark:

TMₙₑₐᵣ=Wᵤₙᵢₜ×Q₁+S_{sound}×Q₂+S_{meaning}×Q₃+S_{keywork}×Q₄=100%×40%+100%×15%+100%×30%+76.67%×15%=40%+15%+30%+11.5%=96.5%.

Finally, the resultant trademarks are sorted using the magnitudes of the comprehensive quantified values of trademark similarity, so that a resultant trademark retrieval list that further meets the trademark sameness or similarity in the sense of the Trademark Law can be clearly displayed.

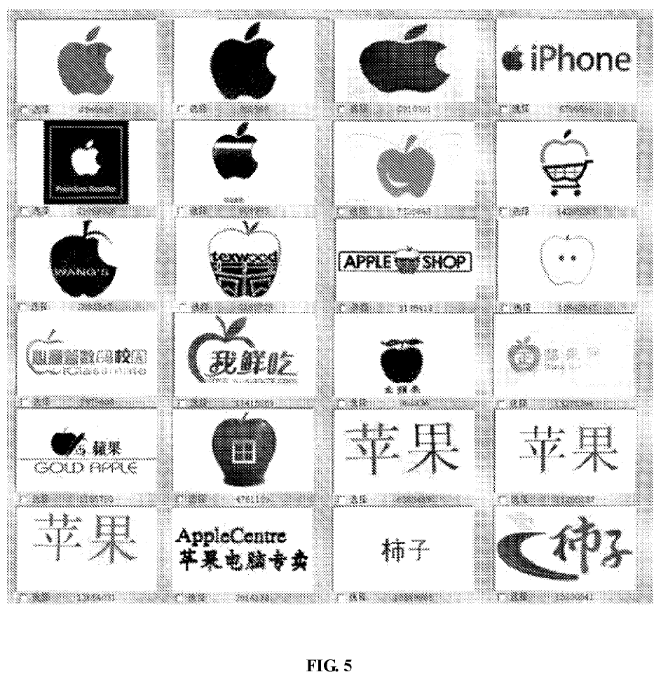

FIG. 5 illustrates a screenshot of report interfaces of the first 24 resultant trademarks sorted by using comprehensive quantified values of trademark similarity. In this embodiment, a graph shown in FIG. 2n is used as an input trademark, a range of commodity is Class 42 of Nice Classification, and a country of registration is China. The screenshot of report interfaces of the first 24 resultant trademarks are acquired by calculation using the comprehensive quantified values of trademark similarity according to the forgoing method.

The method for evaluating and sorting similarities of trademark query results according to the present invention can effectively overcome the defects and drawbacks of the one-sided sorting results or missed detection caused by the traditional single feature sorting method for trademark query results, and can comprehensively reflect the comprehensive features of the trademarks combined in shape, sound and meaning, and improve the accuracy ratio and the recall ratio of the trademark sameness or similarity determination. Using the comprehensive quantified values of trademark similarity effectively quantizes abstract visual results of the trademark images, and greatly improves the quantitative evaluation level of the trademark similarity. The present invention improves the standardization level of the trademark sameness or similarity determination, and narrows the difference between the similarity sorting results of the trademark query results and the sorting results of the trademark sameness or similarity in the sense of the Trademark Law expected by the examiners, preferably evaluates whether the input trademarks and the sample trademarks constitute the trademark sameness or similarity, and accelerates the progress of trademark examination. Moreover, the present invention only needs to input the trademarks to be retrieved into the system once to acquire the optimal comprehensive sorting result, which overcomes the need for the existing trademark retrieval system to continuously perform human-computer interaction to acquire different sorting display results, or avoids too subjective retrieval results caused by artificial screening.

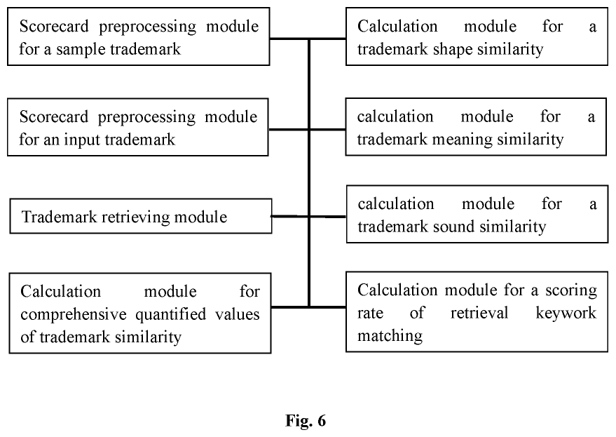

The embodiments of the present invention also relate to a device for evaluating and sorting similarities of trademark query results. FIG. 6 is a schematic structural diagram of a device for evaluating and sorting similarities of trademark query results according to the embodiment of the present invention. The device for evaluating and sorting similarities of trademark query results comprises:

a scorecard preprocessing module for a sample trademark: configured to perform trademark scorecard processing on sample trademark images and contents according to preset trademark scorecard standards, wherein a specific processing procedure comprises: (1) establishing a trademark scorecard standard consisting of preset multiple combination schemes of shape feature minimum units, preset multiple combination schemes of sound feature minimum units, and preset multiple combination schemes of meaning feature minimum units, (2) identifying whether the sample trademarks contain elements of Chinese characters, graphs, letters, numerals or symbols, and acquiring contents of the elements, (3) extracting a shape feature minimum unit, a sound feature minimum unit and a meaning feature minimum unit of each element of the sample trademarks, and (4) according to the established trademark scorecard standard, extracting segmentation information of various characters and graphs generated or converted by each combination scheme, and using the segmentation information as sample trademark scorecard information, and setting a similarity evaluation score for each predetermined preset trademark scorecard standard;

a scorecard processing module for an input trademark: configured to perform trademark scorecard processing on input trademark images and contents according to preset trademark scorecard standards, wherein a specific processing procedure comprises: (1) establishing a trademark scorecard standard consisting of preset multiple combinations of shape feature minimum units, preset multiple combinations of sound feature minimum units, and preset multiple combinations of meaning feature minimum units, (2) identifying whether the input trademark contains elements of Chinese characters, graphs, letters, numbers or symbols, and acquiring contents of the elements, (3) extracting a shape feature minimum unit, a sound feature minimum unit and a meaning feature minimum unit of each element of the input trademark, and (4) according to the established trademark scorecard standard, extracting segmentation information of various characters and graphs generated or converted by each combination scheme, and using the segmentation information as input trademark scorecard information;

a trademark retrieving module: configured to retrieve the sample trademark scorecard information stored in a trademark storage by using an input trademark scorecard information set as a retrieval keywork, and acquire scorecard information and scorecard matching information of relevant resultant trademarks;

a calculation module for a trademark shape similarity: configured to calculate a trademark shape similarity between the input trademarks and the resultant trademarks according to a preset calculation formula for a trademark shape similarity;

a calculation module for a trademark meaning similarity: configured to calculate a trademark meaning similarity between the input trademarks and the resultant trademarks according to a preset calculation formula for a trademark meaning similarity;

a calculation module for a trademark sound similarity: configured to calculate a trademark sound similarity between the input trademarks and the resultant trademarks according to a preset calculation formula for a trademark sound similarity;

a calculation module for a scoring rate of retrieval keywork matching: configured to calculate a scoring rate of retrieval keywork matching between the input trademarks and the resultant trademarks according to a preset calculation formula for a scoring rate of retrieval keywork matching; and

a calculation module for comprehensive quantified values of trademark similarity: configured to acquire comprehensive quantified values of trademark similarity by calculation according to a preset calculation formula for comprehensive quantified values of trademark similarity, and sort the resultant trademarks according to magnitudes of the comprehensive quantified values of trademark similarity.

### Second Embodiment

This embodiment provides a method for evaluating and sorting similarities of trademark query results, and only differs from the first embodiment in that: the order of the first two steps in the method for evaluating and sorting similarities of trademark query results are different. The embodiment specifically comprises the following steps:

step S210: performing trademark scorecard processing on input trademark images and contents according to preset trademark scorecard standards, wherein a specific processing procedure comprises: (1) establishing a trademark scorecard standard consisting of preset multiple combination schemes of shape feature minimum units, preset multiple combination schemes of sound feature minimum units, and preset multiple combination schemes of meaning feature minimum units, (2) identifying whether the input trademarks contain elements of Chinese characters, graphs, letters, numerals or symbols, and acquiring contents of the elements, (3) extracting a shape feature minimum unit, a sound feature minimum unit and a meaning feature minimum unit of each element of the input trademarks, and (4) according to the established trademark scorecard standard, extracting segmentation information of various characters and graphs generated or converted by each combination scheme, and using the segmentation information as input trademark scorecard information;

step S220: performing trademark scorecard processing on sample trademark images and contents according to preset trademark scorecard standards, wherein a specific processing procedure comprises: (1) establishing a trademark scorecard standard consisting of preset multiple combination schemes of shape feature minimum units, preset multiple combination schemes of sound feature minimum units, and preset multiple combination schemes of meaning feature minimum units, (2) identifying whether the sample trademarks contain elements of Chinese characters, graphs, letters, numerals or symbols, and acquiring contents of the elements, (3) extracting a shape feature minimum unit, a sound feature minimum unit and a meaning feature minimum unit of each element of the sample trademarks, and (4) according to the established trademark scorecard standard, extracting segmentation information of various characters and graphs generated or converted by each combination scheme, and using the segmentation information as sample trademark scorecard information, and setting a similarity evaluation score for each predetermined preset trademark scorecard standard;

step S230: retrieving the sample trademark scorecard information stored in a trademark storage by using an input trademark scorecard information set as a retrieval keywork, and acquire scorecard information and scorecard matching information of relevant resultant trademarks;

step S240: according to preset calculation formulas for a trademark shape similarity, a trademark meaning similarity, a trademark sound similarity and a scoring rate of retrieval keywork matching, respectively calculating a trademark shape similarity, a trademark meaning similarity, a trademark sound similarity and a scoring rate of retrieval keywork matching between the input trademarks and the resultant trademarks; and

step S250: according to a preset calculation formula for comprehensive quantified values of trademark similarity, acquiring comprehensive quantified values of trademark similarity by calculation, and sorting the resultant trademarks according to magnitudes of the comprehensive quantified values of trademark similarity.

The technical solutions of the present invention have been described in detail above with reference to the specific embodiments. The specific embodiments are described to help the understanding of the present invention, but are not to be construed as limiting the scope of the present invention. It should be noted that variations, derivations, and changes made by those skilled in the art based on the embodiments of the present invention shall also fall within the scope of the present invention.

1. A method for evaluating and sorting similarities of trademark query results, comprising the following steps:
step S110: performing trademark scorecard processing on sample trademark images and contents according to preset trademark scorecard standards, wherein a specific processing procedure comprises: (1) establishing a trademark scorecard standard consisting of preset multiple combination schemes of shape feature minimum units, preset multiple combination schemes of sound feature minimum units, and preset multiple combination schemes of meaning feature minimum units, (2) identifying whether the sample trademarks contain elements of Chinese characters, graphs, letters, numerals or symbols, and acquiring contents of the elements, (3) extracting a shape feature minimum unit, a sound feature minimum unit and a meaning feature minimum unit of each element of the sample trademarks, and (4) according to the established trademark scorecard standard, extracting segmentation information of various characters and graphs generated or converted by each combination scheme, using the segmentation information as the sample trademark scorecard information, and setting a similarity evaluation score for each preset trademark scorecard standard;
step S120: performing trademark scorecard processing on input trademark images and contents according to preset trademark scorecard standards, wherein a specific processing procedure comprises: (1) establishing a trademark scorecard standard consisting of preset multiple combination schemes of shape feature minimum units, preset multiple combination schemes of sound feature minimum units, and preset multiple combination schemes of meaning feature minimum units, (2) identifying whether the input trademarks contain elements of Chinese characters, graphs, letters, numerals or symbols, and acquiring contents of the elements, (3) extracting a shape feature minimum unit, a sound feature minimum unit and a meaning feature minimum unit of each element of the input trademarks, and (4) according to the established trademark scorecard standard, extracting segmentation information of various characters and graphs generated or converted by each combination scheme, and using the segmentation information as input trademark scorecard information;
step S130: retrieving the sample trademark scorecard information stored in a trademark storage by using an input trademark scorecard information set as a retrieval keywork, and acquiring scorecard information and scorecard matching information of relevant resultant trademarks;
step S140: according to preset calculation formulas for a trademark shape similarity, a trademark meaning similarity, a trademark sound similarity and a scoring rate of retrieval keywork matching, respectively calculating a trademark shape similarity, a trademark meaning similarity, a trademark sound similarity and a scoring rate of retrieval keywork matching between the input trademarks and the resultant trademarks; and
step S150: according to a preset calculation formula for comprehensive quantified values of trademark similarity, acquiring comprehensive quantified values of trademark similarity by calculation, and sorting the resultant trademarks according to magnitudes of the comprehensive quantified values of trademark similarity,
the shape feature minimum units comprising:
a shape feature minimum unit the elements of which are Chinese characters, and selected from one of the followings: each Chinese character, and each stroke of each Chinese character;
a shape feature minimum unit the elements of which are graphs, and selected from one of the followings: a trademark graph element code, and a pixel set with a preset length on a trademark image contour line;
a shape feature minimum unit the elements of which are letters, and selected from one of the followings: words in each language, and each letter;
a shape feature minimum unit the elements of which are Chinese numerals, and selected from one of the followings: a combination of Chinese numerals, and each single Chinese numeral;
a shape feature minimum unit the elements of which are Arabic numerals, and selected from one of the followings: a combination of Arabic numerals, and each single Arabic numeral;
a shape feature minimum unit the elements of which are numerals in other languages, and selected from one of the followings: a combination of numerals in other languages, and each single numeral in other languages; and
a shape feature minimum unit the elements of which are symbols: each signal symbol;
the meaning feature minimum units comprising:
a meaning feature minimum unit the elements of which are Chinese characters: when an overall combination of Chinese characters of a trademark is composed of a combination of vocabularies recorded in a Chinese dictionary, each vocabulary is the meaning feature minimum unit; otherwise, the overall combination of Chinese characters of the trademark is the meaning feature minimum unit;
a meaning feature minimum unit the elements of which are graphs: a name of each thing corresponding to the trademark graph element code;
a meaning feature minimum unit the elements of which are letters: when an overall combination of letters of the trademark is composed of a combination of words recorded in an English dictionary, or a combination of words recorded in a dictionary in other languages, each word is the meaning feature minimum unit; otherwise, the overall letter combination of the trademark is the meaning feature minimum unit;
a meaning feature minimum units the elements of which are Chinese numerals, and selected from one of the followings: numerals in a preset reference language corresponding to each group of Chinese numerals separated in the trademark, and numerals in a preset reference language corresponding to each single Chinese numeral in the trademark, wherein the numerals in the preset reference language are numerals in any languages;
a meaning feature minimum units the elements of which are Arabic numerals, and selected from one of the followings: numerals in a preset reference language corresponding to each group of Arabic numerals separated in the trademark, and numerals in a preset reference language corresponding to each single Arabic numeral in the trademark, wherein the numerals in the preset reference language are numerals in any languages;
a meaning feature minimum units the elements of which are numerals in other languages, and selected from one of the followings: numerals in a preset reference language corresponding to each group of numeral in other languages separated in the trademark, and numerals in a preset reference language corresponding to each single numeral in other languages in the trademark, wherein the numerals in the preset reference language are numerals in any languages; and
a meaning feature minimum units the elements of which are symbols: a symbolic name corresponding to each symbol in the trademark;
the sound feature minimum units comprising:
a sound feature minimum units the elements of which are Chinese characters: Pinyin of each Chinese character;
a sound feature minimum unit the elements of which are graphs: Pinyin of a name of each thing corresponding to the trademark graph element code;
a sound feature minimum units the elements of which are letters, and selected from one of the followings: a sound of each combination of letters, and a sound of each letter; and
a sound feature minimum units the elements of which are numerals or symbols, and selected from one of the followings: a sound of each group of numerals separated in the trademark, a sound of each single numeral, a sound of each group of symbols separated in the trademark, and a sound of each single symbol; and
the trademark scorecard standard comprising:
A. a trademark scorecard standard consisting of multiple combination schemes of the shape feature minimum units the elements of which are Chinese characters, comprising: at least one of scorecard standards a₁, a₂, a₃, a₄, a₅, a₆, a₇, a₈, a₉, a₁₀, a₁₁, a₁₂ and a₁₃, wherein:
a₁ indicates that an overall combination of characters in all languages and graph element codes of the trademark arranged in order is segmented into one scorecard,
a₂ indicates that an overall combination of characters in all languages and graph element codes of the trademark arranged in a reversed order is segmented into one scorecard,
a₃ indicates that Chinese characters in the trademark arranged in order are segmented into one scorecard,
a₄ indicates that Chinese characters in the trademark arranged in a reversed order are segmented into one scorecard,
a₅ indicates that Chinese numerals in the trademark arranged in order are segmented into one scorecard,
a₆ indicates that Chinese numerals in the trademark arranged in a reversed order are segmented into one scorecard,
a₇ indicates that each relatively independent part in the trademark is segmented into one scorecard respectively,
a₈ indicates that the characters in the trademark completely contain the existing trademark in Chinese characters, and the part is segmented into one scorecard,
a₉ indicates that traditional and variant Chinese characters contained in the trademark are converted into simplified Chinese characters and then segmented into one scorecard,
a₁₀ indicates that each character in the trademark after being replaced by a shape-approximate character is segmented into one scorecard,
a₁₁ indicates that every adjacent Chinese characters in the trademark are segmented into one scorecard respectively,
a₁₂ indicates that a combination of first and last Chinese characters in the trademark is segmented into one scorecard, and
a₁₃ indicates that each Chinese character in the trademark is segmented into one scorecard;
B. a trademark scorecard standard consisting of multiple combination schemes of the shape feature minimum units the elements of which are letters, numerals and symbols, comprising: at least one of scorecard standards b₁, b₂, b₃, b₄, b₅, b₆, b₇, b₈, b₉, b₁₀, b₁₁, b₁₂, b₁₃ and b₁₄, wherein:
b₁ indicates that an overall combination of characters in all languages and graph element codes of the trademark arranged in order is segmented into one scorecard,
b₂ indicates that the overall combination of characters in all languages and graph element codes of the trademark arranged in a reversed order is segmented into one scorecard,
b₃ indicates that a combination of letters in the trademark arranged in order is segmented into one scorecard,
b₄ indicates that a combination of letters in the trademark arranged in a reversed order is segmented into one scorecard,
b₅ indicates that non-Chinese numerals contained in the trademark arranged in order or each single non-Chinese numeral is segmented into one scorecard respectively,
b₆ indicates that non-Chinese numerals contained in the trademark arranged in a reversed order or each single non-Chinese numeral is segmented into one scorecard respectively,
b₇ indicates that a combination of symbols contained in the trademark arranged in order is segmented into one scorecard,
b₈ indicates that a combination of symbols contained in the trademark arranged in a reversed order is segmented into one scorecard,
b₉ indicates that each relatively independent part in the trademark is segmented into one scorecard respectively,
b₁₀ indicates that each letter in the trademark after being replaced by a shape-approximate letter is segmented into one scorecard,
b₁₁ indicates that a combination of every adjacent letters in the trademark is segmented into one scorecard respectively,
b₁₂ indicates that letters in the trademark are arranged in different orders, and then segmented into one scorecard respectively,
b₁₃ indicates that a combination of first and last letters in the trademark is segmented into one scorecard, and
b₁₄ indicates that each letter, or numeral, or symbol in the trademark is segmented into one scorecard respectively;
C. a trademark scorecard standard consisting of multiple combination schemes of the shape feature minimum units the elements of which are graphs, comprising: at least one of scorecard standards c₁, c₂, c₃ and c₄, wherein:
c₁ indicates that a trademark graph element code set is entirely segmented into one scorecard,
c₂ indicates that each trademark graph element code is segmented into one scorecard,
c₃ indicates that an entirety of trademark image feature descriptors generated by each image feature recognition method is segmented into one scorecard respectively,
c₄ indicates that a preset length of the trademark image feature descriptor generated by each image feature recognition method is segmented into one scorecard respectively, and the preset length of the trademark image feature descriptor refers to a preset length of consecutively connected pixels on a trademark image contour line, the consecutively connected pixels are represented by a feature character string set or a numeral set, and a value ranges from 0.1% to 50% of an overall length of the trademark image feature descriptor or the numeral set;
D. a trademark scorecard standard consisting of multiple combination schemes of the sound feature minimum units the elements of which are Chinese characters, comprising: at least one of scorecard standards d₁, d₂ and d₃, wherein:
d₁ indicates that a Pinyin syllable of each Chinese character in the trademark is segmented into one scorecard,
d₂ indicates that Pinyin syllables corresponding to the overall Chinese characters in the trademark are segmented into one scorecard, and
d₃ indicates that the Pinyin syllable of each Chinese character in the trademark after being replaced by a shape-approximate character is segmented into one scorecard,
E. a trademark scorecard standard consisting of multiple combination schemes of the sound feature minimum units the elements of which are letters, numerals and symbols, comprising: at least one of scorecard standards e₁, e₂, e₃ and e₄, wherein:
e₁ indicates that a sound syllable of each English word in the trademark is segmented into one scorecard,
e₂ indicates that an overall combination of letters acquired by replacing a combination of letters in the trademark by a combination of sound-approximate letters is segmented into one scorecard respectively,
e₃ indicates that a sound syllable of each numeral in the trademark is segmented into one scorecard, and
e₄ indicates that a sound syllable of each symbol in the trademark is segmented into one scorecard;
F. a trademark scorecard standard consisting of multiple combination schemes of the sound feature minimum units the elements of which are graphs, comprising: a scorecard standard f₁, wherein f₁ indicates that a pinyin of a name of each thing corresponding to the trademark graph element code is segmented into one scorecard;
G. a trademark scorecard standard consisting of multiple combination schemes of the meaning feature minimum units the elements of which are Chinese characters, comprising: at least one of scorecard standards g₁, g₂, g₃ and g₄, wherein:
g₁ indicates that the trademark completely contains existing Chinese character trademarks in a trademark server, and the entire trademark is meaningless, and the part containing the existing Chinese character trademarks is segmented into one scorecard,
g₂ indicates that the vocabularies recorded in the Chinese dictionary or a combination of Chinese characters of the existing Chinese character trademarks in the trademark server are completely matched with the trademark, and the matching parts are segmented into one scorecard respectively,
g₃ indicates that Chinese vocabularies contained in the trademark after being replaced by synonyms are segmented into one scorecard respectively, and
g₄ indicates that the overall trademark is meaningless, and the overall Chinese characters are segmented into one scorecard;
H. a trademark scorecard standard consisting of multiple combination schemes of the meaning feature minimum units the elements of which are letters, numerals and symbol combinations, comprising: at least one of scorecard standards h₁, h₂, h₃, h₄, h₅, h₆, h₇, h₈ and h₉, wherein:
h₁ indicates that the overall combination of letters of the trademark is composed of a combination of words recorded in an English dictionary or dictionary in other languages, and the overall combination of words is segmented into one scorecard,
h₂ indicates that the trademark contains words recorded in the English dictionary or dictionary in other languages, and each word is segmented into one scorecard,
h₃ indicates that the trademark contains words recorded in the English dictionary or dictionary in other languages, and a synonym of each word is segmented into one scorecard,
h₄ indicates that the overall combination of letters of the trademark is not matched with the words recorded in the English dictionary or dictionary in other languages, and the overall combination of letters is segmented into one scorecard,
h₅ indicates that each group of numerals separated in the trademark is segmented into one scorecard,
h₆ indicates that the overall combination of numerals of the trademark is segmented into one scorecard,
h₇ indicates that the overall combination of symbols of the trademark is segmented into one scorecard,
h₈ indicates that each symbol of the trademark is segmented into one scorecard, and
h₉ indicates that the trademark completely contains a trademark of the existing combination of letters in the trademark server, and the entire trademark is meaningless, and a part containing the trademark of the existing combination of letters is segmented into one scorecard;
I. a trademark scorecard standard consisting of multiple combination schemes of the meaning feature minimum units the elements of which are graphs, comprising: at least one of scorecard standards i₁ and i₂, wherein:
i₁ indicates that the name of each thing corresponding to the trademark graph element code is segmented into one scorecard, and
i₂ indicates that the trademark image feature descriptors correspond to the trademark graph element codes, and the name of each thing corresponding to the trademark graph element codes is segmented into one scorecard; and
Y. a trademark scorecard standard consisting of multiple combination schemes of minimum units the elements of which are exceptional adjustment characters, comprising: at least one of scorecard standards y₁ and y₂, wherein:
yᵢ indicates that the trademark contains the exceptional adjustment characters, and the overall exceptional adjustment characters are segmented into one scorecard, and
y₂ indicates that the trademark contains the exceptional adjustment characters, and each character of the overall exceptional adjustment characters is segmented into one scorecard respectively.

2. (canceled)

3. The method for evaluating and sorting similarities of trademark query results according to claim 1, wherein the exceptional adjustment characters comprise more than one of the following characters: geographical names of administrative areas above the county level, foreign geographical names known to the public, generic names of commodities, vocabularies indicating quality, main materials, functions, uses, weights, quantities, and other characteristics of commodities, generic names of commodities and services, and characters with weak significance.

4. The method for evaluating and sorting similarities of trademark query results according to claim 1, wherein the “input trademark scorecard information” in the step S120 comprises: U₀, β₁, V₀, β₂, M₀ and Y₀, wherein U₀ indicates a number of scorecards of the input trademarks acquired on the basis of the trademark scorecard standards a₁₃, b₁₄, c₂, c₄ or a combination thereof; β₁ indicates a number of scorecards or a number of characters of the exceptional adjustment characters contained in the input trademarks and acquired on the basis of the scorecard standards a₁₃, b₁₄, c₂ and c₄; V₀ indicates a number of scorecards of the input trademarks acquired on the basis of the trademark scorecard standards d₁, d₂, d₃, e₁, e₂, e₃, e₄ or a combination thereof; β₂ indicates a number of scorecards or a number of syllables of the exceptional adjustment characters contained in the input trademarks and acquired on the basis of the scorecard standards d₁, d₂, d₃, e₁, e₂, e₃ and e₄; M₀ indicates a number of scorecards of the input trademarks after removing the exceptional adjustment characters matched with the scorecards of the resultant trademarks acquired on the basis of the trademark scorecard standards g₁, g₂, g₃ and g₄; and Y₀ indicates a number of scorecards of the input trademark acquired on the basis of the trademark scorecard standard y₁ or y₂;
the “scorecard information and scorecard matching information of the resultant trademarks” in the step S130 comprise Yₐ, Uₐ, U_{b}, U_{c}, Vₐ, V_{b}, V_{c}, M₁, M₂, M₃, M₄, Jᵢ, n, kᵢ, r and Tᵢ, wherein Yₐ indicates a number of scorecards of the resultant trademarks acquired on the basis of the trademark scorecard standard y₁ or y₂; Uₐ indicates a number of scorecards of the resultant trademarks after removing the exceptional adjustment characters matched with the scorecards of the input trademarks acquired on the basis of the trademark scorecard standards a₁₃, b₁₄, c₂, c₄ or a combination thereof; U_{b} indicates a number of scorecards of the resultant trademarks after removing the exceptional adjustment characters matched with the scorecards of the input trademarks acquired on the basis of the trademark scorecard standards a₁₀, b₁₀ or a combination thereof; U_{c} indicates a number of places where mismatched scorecards are inserted between the matched scorecards of the resultant trademarks and the input trademarks acquired on the basis of the trademark scorecard standards a₁₃, b₁₄, c₂, c₄ or a combination thereof and the trademark scorecard standards a₁₀, b₁₀ or a combination thereof; Vₐ indicates a number of scorecards of the resultant trademarks after removing the exceptional adjustment characters matched with the scorecards of the input trademarks acquired on the basis of the trademark scorecard standards d₁, d₂, e₁, e₃, e₄ or a combination thereof; V_{b} indicates a number of scorecards of the resultant trademarks after removing the exceptional adjustment characters matched with the scorecards of the input trademarks acquired on the basis of the trademark scorecard standards d₃, e₂ or a combination thereof; V_{c} indicates a number of places where mismatched scorecards are inserted between the matched scorecards of the resultant trademarks and the input trademarks acquired on the basis of the trademark scorecard standards d₁, d₂, e₁, e₃, e₄ or a combination thereof and the trademark scorecard standards d₃, e₂ or a combination thereof; M₁ indicates a compared number of scorecards of the resultant trademarks after removing the exceptional adjustment characters matched with the input trademarks on the basis of the trademark scorecard standard g₁; M₂ indicates a compared number of scorecards of the resultant trademarks after removing the exceptional adjustment characters matched with the input trademarks on the basis of the trademark scorecard standard g₂; M₃ indicates a compared number of scorecards of the resultant trademarks after removing the exceptional adjustment characters matched with the input trademarks on the basis of the trademark scorecard standard g₃; M₄ indicates a compared number of scorecards of the resultant trademarks after removing the exceptional adjustment characters matched with the input trademarks on the basis of the trademark scorecard standard g₄; Jᵢ indicates a preset similarity evaluation score of the trademark scorecard standard corresponding to an i^{th} scorecard where the resultant trademarks are matched with the input trademarks; n indicates a number of scorecard items where the resultant trademarks are matched with the input trademarks; kᵢ indicates an average score of the preset similarity evaluation scores of the trademark scorecard standards corresponding to each scorecard where the resultant trademarks are matched with the input trademarks in an i^{th} feature type, r indicates a number of feature types of the resultant trademarks matched with the input trademarks; and Tᵢ indicates the highest score among the preset similarity evaluation scores of the trademark scorecard standards corresponding to each scorecard where the resultant trademarks are matched with the input trademarks in the i^{th} feature type; and
the feature type is a scorecard category acquired by classifying the trademark scorecard information by a preset classification standard.

5. The method for evaluating and sorting similarities of trademark query results according to claim 4, wherein the feature type, according to the shape, sound and meaning, comprises: a shape feature type, a sound feature type, and a meaning feature type; and, according to the contents of the elements, comprises: a Chinese character feature type, a letter character feature type, a numeral character feature type, a symbol character feature type, a graph element code graph feature type, and an image feature descriptor graph feature type.

6. The method for evaluating and sorting similarities of trademark query results according to claim 4, wherein the “preset calculation formulas for a trademark shape similarity, a trademark meaning similarity, a trademark sound similarity and a scoring rate of retrieval keywork matching” in the step S140 comprise:
1) the calculation formula for a trademark shape similarity, comprising:
Wᵤₙᵢₜ=Uₐ/(U₀−β₁)+[U_{b}/(U₀−β₁)]×λ₁−[U_{c}/(U₀−β₁)]×λ₂
wherein, Wᵤₙᵢₜ indicates the trademark shape similarity, λ₁ and λ₂ are preset adjustment weights both ranging from 10% to 300%;
2) the calculation formula for a trademark sound similarity, comprising
S_{sound}=Vₐ/(V₀−β₂)+[V_{b}/(V₀−β₂)]×μ₁−[V_{c}/(V₀−β₂)]×μ₂
wherein, S_{sound} indicates the trademark sound similarity, μ₁ and μ₂ are preset adjustment weights both ranging from 10% to 300%;
3) the calculation formula for a trademark meaning similarity, comprising:
S_{meaning}[(M₁+M₂×α₁+M₃×α₂+M₄×α₃)/M₀]−θ
wherein, S_{meaning} indicates the trademark meaning similarity, α₁, α₂ and α₃ respectively indicate adjustment parameters for M₂, M₃ and M₄, and value rules are as follows: when two or more parameters of M₁, M₂, M₃ and M₄ are not 0 at the same time, the first parameter in M₁, M₂, M₃ and M₄ is a valid parameter, and the rest are invalid parameters, and when M₁ is not 0, α₁, α₂ and α₃ are 0; when M₁ is 0 and M₂ is not 0, α₁, α₂ and α₃ are 0; when M₁ and M₂ are 0, and M₃ is not 0, α₂ is 1, and α₃ is 0; when M₁, M₂ and M₃ are 0, and M₄ is not 0, α₃ is 1; and θ indicates an adjustment parameter adjustment with different number of trademark characters between the input trademarks and the compared resultant trademarks, ranging from 1% to 90%; and
4) the calculation formula for a scoring rate of retrieval keywork matching, comprising at least one of the followings: a comprehensive average scoring rate of retrieval keywork matching, an average scoring rate of retrieval keywork matching classification, a highest scoring rate of retrieval keywork matching classification, and a highest weighted scoring rate of retrieval keywork matching classification, namely:
S_{keywork}=S₁, or S_{keywork}=S₂, S_{keywork}=S₃, or S_{keywork}=S₄
wherein, S_{keywork} indicates the scoring rate of retrieval keywork matching, S₁ indicates the comprehensive average scoring rate of retrieval keywork matching, S₂ indicates the average scoring rate of retrieval keywork matching classification, S₃ indicates the highest scoring rate of retrieval keywork matching classification, and S₄ indicates the highest weighted scoring rate of retrieval keywork matching classification; and
calculation formulas for S₁, S₂, S₃ and S₄ are respectively as follows:
S₁=J₁+J₂+J₃+ . . . +Jₙ/n
S₂=(k₁+k₂+k₃+ . . . +kᵣ)/r
S₃=(T₁+T₂+T₃+ . . . +Tᵣ)/r
S₄=T₁×ω₁+T₂×ω₂+T₃×ω₃+ . . . +Tᵣ×ωᵣ
wherein, ω₁, ω₂, ω₃, . . . , and ωᵣ respectively indicate calculation weights of highest scores in the preset similarity evaluation scores of the scorecard standards corresponding to the scorecards where the resultant trademarks are matched with the input trademarks in a first feature type, a second feature type, a third feature type, . . . , and an r^{th} feature type, and ω₁, ω₂, ω₃, . . . and ωᵣ range from 1% to 80%, and the total of all the calculation weights is 100%.

7. The method for evaluating and sorting similarities of trademark query results according to claim 6, wherein the “calculation formula for comprehensive quantified values of trademark similarity” in the step S150 comprises:
TMₙₑₐᵣ=Wᵤₙᵢₜ×Q₁+S_{sound}×Q₂+S_{meaning}×Q₃+S_{keywork}×Q₄
wherein, TM near indicates the comprehensive quantified values of trademark similarity, Wᵤₙᵢₜ indicates the trademark shape similarity, S_{sound} indicates the trademark sound similarity, S_{meaning} indicates the trademark meaning similarity, S_{keywork} indicates the scoring rate of retrieval keywork matching, Q₁, Q₂, Q₃ and Q₄ respectively indicate weights of the trademark shape similarity, the trademark sound similarity, the trademark meaning similarity and the scoring rate of retrieval keywork matching, Q₁, Q₂, Q₃ and Q₄ range from 5% to 95%, and the total of all the calculation weights is 100%.

8. A device for evaluating and sorting similarities of trademark query results, comprising:
a scorecard preprocessing module for a sample trademark: configured to perform trademark scorecard processing on sample trademark images and contents according to preset trademark scorecard standards, wherein a specific processing procedure comprises: (1) establishing a trademark scorecard standard consisting of preset multiple combination schemes of shape feature minimum units, preset multiple combination schemes of sound feature minimum units, and preset multiple combination schemes of meaning feature minimum units, (2) identifying whether the sample trademarks contain elements of Chinese characters, graphs, letters, numerals or symbols, and acquiring contents of the elements, (3) extracting a shape feature minimum unit, a sound feature minimum unit and a meaning feature minimum unit of each element of the sample trademarks, and (4) according to the established trademark scorecard standard, extracting segmentation information of various characters and graphs generated or converted by each combination scheme, using the segmentation information as the sample trademark scorecard information, and setting a similarity evaluation score for each preset trademark scorecard standard;
a scorecard processing module for an input trademark: configured to perform trademark scorecard processing on input trademark images and contents according to preset trademark scorecard standards, wherein a specific processing procedure comprises: (1) establishing a trademark scorecard standard consisting of preset multiple combinations of shape feature minimum units, preset multiple combinations of sound feature minimum units, and preset multiple combinations of meaning feature minimum units, (2) identifying whether the input trademark contains elements of Chinese characters, graphs, letters, numbers or symbols, and acquiring contents of the elements, (3) extracting a shape feature minimum unit, a sound feature minimum unit and a meaning feature minimum unit of each element of the input trademark, and (4) according to the established trademark scorecard standard, extracting segmentation information of various characters and graphs generated or converted by each combination scheme, and using the segmentation information as input trademark scorecard information;
a trademark retrieving module: configured to retrieve the sample trademark scorecard information stored in a trademark storage by using an input trademark scorecard information set as a retrieval keywork, and acquire scorecard information and scorecard matching information of relevant resultant trademarks;
a calculation module for a trademark shape similarity: configured to calculate a trademark shape similarity between the input trademarks and the resultant trademarks according to a preset calculation formula for a trademark shape similarity;
a calculation module for a trademark meaning similarity: configured to calculate a trademark meaning similarity between the input trademarks and the resultant trademarks according to a preset calculation formula for a trademark meaning similarity;
a calculation module for a trademark sound similarity: configured to calculate a trademark sound similarity between the input trademarks and the resultant trademarks according to a preset calculation formula for a trademark sound similarity;
a calculation module for a scoring rate of retrieval keywork matching: configured to calculate a scoring rate of retrieval keywork matching between the input trademarks and the resultant trademarks according to a preset calculation formula for a scoring rate of retrieval keywork matching; and
a calculation module for comprehensive quantified values of trademark similarity: configured to acquire comprehensive quantified values of trademark similarity by calculation according to a preset calculation formula for comprehensive quantified values of trademark similarity, and sort the resultant trademarks according to magnitudes of the comprehensive quantified values of trademark similarity,
the shape feature minimum units comprising:
a shape feature minimum unit the elements of which are Chinese characters, and selected from one of the followings: each Chinese character, and each stroke of each Chinese character;
a shape feature minimum unit the elements of which are graphs, and selected from one of the followings: a trademark graph element code, and a pixel set with a preset length on a trademark image contour line;
a shape feature minimum unit the elements of which are letters, and selected from one of the followings: words in each language, and each letter;
a shape feature minimum unit the elements of which are Chinese numerals, and selected from one of the followings: a combination of Chinese numerals, and each single Chinese numeral;
a shape feature minimum unit the elements of which are Arabic numerals, and selected from one of the followings: a combination of Arabic numerals, and each single Arabic numeral;
a shape feature minimum unit the elements of which are numerals in other languages, and selected from one of the followings: a combination of numerals in other languages, and each single numeral in other languages; and
a shape feature minimum unit the elements of which are symbols: each signal symbol;
the meaning feature minimum units comprising:
a meaning feature minimum unit the elements of which are Chinese characters:
when an overall combination of Chinese characters of a trademark is composed of a combination of vocabularies recorded in a Chinese dictionary, each vocabulary is the meaning feature minimum unit; otherwise, the overall combination of Chinese characters of the trademark is the meaning feature minimum unit;
a meaning feature minimum unit the elements of which are graphs: a name of each thing corresponding to the trademark graph element code;
a meaning feature minimum unit the elements of which are letters: when an overall combination of letters of the trademark is composed of a combination of words recorded in an English dictionary, or a combination of words recorded in a dictionary in other languages, each word is the meaning feature minimum unit; otherwise, the overall letter combination of the trademark is the meaning feature minimum unit;
a meaning feature minimum units the elements of which are Chinese numerals, and selected from one of the followings: numerals in a preset reference language corresponding to each group of Chinese numerals separated in the trademark, and numerals in a preset reference language corresponding to each single Chinese numeral in the trademark, wherein the numerals in the preset reference language are numerals in any languages;
a meaning feature minimum units the elements of which are Arabic numerals, and selected from one of the followings: numerals in a preset reference language corresponding to each group of Arabic numerals separated in the trademark, and numerals in a preset reference language corresponding to each single Arabic numeral in the trademark, wherein the numerals in the preset reference language are numerals in any languages;
a meaning feature minimum units the elements of which are numerals in other languages, and selected from one of the followings: numerals in a preset reference language corresponding to each group of numeral in other languages separated in the trademark, and numerals in a preset reference language corresponding to each single numeral in other languages in the trademark, wherein the numerals in the preset reference language are numerals in any languages; and
a meaning feature minimum units the elements of which are symbols: a symbolic name corresponding to each symbol in the trademark;
the sound feature minimum units comprising:
a sound feature minimum units the elements of which are Chinese characters: Pinyin of each Chinese character;
a sound feature minimum unit the elements of which are graphs: Pinyin of a name of each thing corresponding to the trademark graph element code;
a sound feature minimum units the elements of which are letters, and selected from one of the followings: a sound of each combination of letters, and a sound of each letter; and
a sound feature minimum units the elements of which are numerals or symbols, and selected from one of the followings: a sound of each group of numerals separated in the trademark, a sound of each single numeral, a sound of each group of symbols separated in the trademark, and a sound of each single symbol; and
the trademark scorecard standard comprising:
A. a trademark scorecard standard consisting of multiple combination schemes of the shape feature minimum units the elements of which are Chinese characters, comprising: at least one of scorecard standards a₁, a₂, a₃, a₄, a₅, a₆, a₇, a₈, a₉, a₁₀, a₁₁, a₁₂ and a₁₃, wherein:
a₁ indicates that an overall combination of characters in all languages and graph element codes of the trademark arranged in order is segmented into one scorecard,
a₂ indicates that an overall combination of characters in all languages and graph element codes of the trademark arranged in a reversed order is segmented into one scorecard,
a₃ indicates that Chinese characters in the trademark arranged in order are segmented into one scorecard,
a₄ indicates that Chinese characters in the trademark arranged in a reversed order are segmented into one scorecard,
a₅ indicates that Chinese numerals in the trademark arranged in order are segmented into one scorecard,
a₆ indicates that Chinese numerals in the trademark arranged in a reversed order are segmented into one scorecard,
a₇ indicates that each relatively independent part in the trademark is segmented into one scorecard respectively,
a₈ indicates that the characters in the trademark completely contain the existing trademark in Chinese characters, and the part is segmented into one scorecard,
a₉ indicates that traditional and variant Chinese characters contained in the trademark are converted into simplified Chinese characters and then segmented into one scorecard,
a₁₀ indicates that each character in the trademark after being replaced by a shape-approximate character is segmented into one scorecard,
a₁₁ indicates that every adjacent Chinese characters in the trademark are segmented into one scorecard respectively,
a₁₂ indicates that a combination of first and last Chinese characters in the trademark is segmented into one scorecard, and
a₁₃ indicates that each Chinese character in the trademark is segmented into one scorecard;
B. a trademark scorecard standard consisting of multiple combination schemes of the shape feature minimum units the elements of which are letters, numerals and symbols, comprising: at least one of scorecard standards b₁, b₂, b₃, b₄, b₅, b₆, b₇, b₈, b₉, b₁₀, b₁₁, b₁₂, b₁₃ and b₁₄, wherein:
b₁ indicates that an overall combination of characters in all languages and graph element codes of the trademark arranged in order is segmented into one scorecard,
b₂ indicates that the overall combination of characters in all languages and graph element codes of the trademark arranged in a reversed order is segmented into one scorecard,
b₃ indicates that a combination of letters in the trademark arranged in order is segmented into one scorecard,
b₄ indicates that a combination of letters in the trademark arranged in a reversed order is segmented into one scorecard,
b₅ indicates that non-Chinese numerals contained in the trademark arranged in order or each single non-Chinese numeral is segmented into one scorecard respectively,
b₆ indicates that non-Chinese numerals contained in the trademark arranged in a reversed order or each single non-Chinese numeral is segmented into one scorecard respectively,
b₇ indicates that a combination of symbols contained in the trademark arranged in order is segmented into one scorecard,
b₈ indicates that a combination of symbols contained in the trademark arranged in a reversed order is segmented into one scorecard,
b₉ indicates that each relatively independent part in the trademark is segmented into one scorecard respectively,
b₁₀ indicates that each letter in the trademark after being replaced by a shape-approximate letter is segmented into one scorecard,
b₁₁ indicates that a combination of every adjacent letters in the trademark is segmented into one scorecard respectively,
b₁₂ indicates that letters in the trademark are arranged in different orders, and then segmented into one scorecard respectively,
b₁₃ indicates that a combination of first and last letters in the trademark is segmented into one scorecard, and
b₁₄ indicates that each letter, or numeral, or symbol in the trademark is segmented into one scorecard respectively;
C. a trademark scorecard standard consisting of multiple combination schemes of the shape feature minimum units the elements of which are graphs, comprising: at least one of scorecard standards c₁, c₂, c₃ and c₄, wherein:
c₁ indicates that a trademark graph element code set is entirely segmented into one scorecard,
c₂ indicates that each trademark graph element code is segmented into one scorecard,
c₃ indicates that an entirety of trademark image feature descriptors generated by each image feature recognition method is segmented into one scorecard respectively,
c₄ indicates that a preset length of the trademark image feature descriptor generated by each image feature recognition method is segmented into one scorecard respectively, and the preset length of the trademark image feature descriptor refers to a preset length of consecutively connected pixels on a trademark image contour line, the consecutively connected pixels are represented by a feature character string set or a numeral set, and a value ranges from 0.1% to 50% of an overall length of the trademark image feature descriptor or the numeral set;
D. a trademark scorecard standard consisting of multiple combination schemes of the sound feature minimum units the elements of which are Chinese characters, comprising: at least one of scorecard standards d₁, d₂ and d₃, wherein:
d₁ indicates that a Pinyin syllable of each Chinese character in the trademark is segmented into one scorecard,
d₂ indicates that Pinyin syllables corresponding to the overall Chinese characters in the trademark are segmented into one scorecard, and
d₃ indicates that the Pinyin syllable of each Chinese character in the trademark after being replaced by a shape-approximate character is segmented into one scorecard,
E. a trademark scorecard standard consisting of multiple combination schemes of the sound feature minimum units the elements of which are letters, numerals and symbols, comprising: at least one of scorecard standards e₁, e₂, e₃ and e₄, wherein:
e₁ indicates that a sound syllable of each English word in the trademark is segmented into one scorecard,
e₂ indicates that an overall combination of letters acquired by replacing a combination of letters in the trademark by a combination of sound-approximate letters is segmented into one scorecard respectively,
e₃ indicates that a sound syllable of each numeral in the trademark is segmented into one scorecard, and
e₄ indicates that a sound syllable of each symbol in the trademark is segmented into one scorecard;
F. a trademark scorecard standard consisting of multiple combination schemes of the sound feature minimum units the elements of which are graphs, comprising: a scorecard standard f₁, wherein f₁ indicates that a pinyin of a name of each thing corresponding to the trademark graph element code is segmented into one scorecard;
G. a trademark scorecard standard consisting of multiple combination schemes of the meaning feature minimum units the elements of which are Chinese characters, comprising: at least one of scorecard standards g₁, g₂, g₃ and g₄, wherein:
g₁ indicates that the trademark completely contains existing Chinese character trademarks in a trademark server, and the entire trademark is meaningless, and the part containing the existing Chinese character trademarks is segmented into one scorecard,
g₂ indicates that the vocabularies recorded in the Chinese dictionary or a combination of Chinese characters of the existing Chinese character trademarks in the trademark server are completely matched with the trademark, and the matching parts are segmented into one scorecard respectively,
g₃ indicates that Chinese vocabularies contained in the trademark after being replaced by synonyms are segmented into one scorecard respectively, and
g₄ indicates that the overall trademark is meaningless, and the overall Chinese characters are segmented into one scorecard;
H. a trademark scorecard standard consisting of multiple combination schemes of the meaning feature minimum units the elements of which are letters, numerals and symbol combinations, comprising: at least one of scorecard standards h₁, h₂, h₃, h₄, h₅, h₆, h₇, h₈ and h₉, wherein:
h₁ indicates that the overall combination of letters of the trademark is composed of a combination of words recorded in an English dictionary or dictionary in other languages, and the overall combination of words is segmented into one scorecard,
h₂ indicates that the trademark contains words recorded in the English dictionary or dictionary in other languages, and each word is segmented into one scorecard,
h₃ indicates that the trademark contains words recorded in the English dictionary or dictionary in other languages, and a synonym of each word is segmented into one scorecard,
h₄ indicates that the overall combination of letters of the trademark is not matched with the words recorded in the English dictionary or dictionary in other languages, and the overall combination of letters is segmented into one scorecard,
h₅ indicates that each group of numerals separated in the trademark is segmented into one scorecard,
h₆ indicates that the overall combination of numerals of the trademark is segmented into one scorecard,
h₇ indicates that the overall combination of symbols of the trademark is segmented into one scorecard,
h₈ indicates that each symbol of the trademark is segmented into one scorecard, and
h₉ indicates that the trademark completely contains a trademark of the existing combination of letters in the trademark server, and the entire trademark is meaningless, and a part containing the trademark of the existing combination of letters is segmented into one scorecard;
I. a trademark scorecard standard consisting of multiple combination schemes of the meaning feature minimum units the elements of which are graphs, comprising: at least one of scorecard standards i₁ and i₂, wherein:
i₁ indicates that the name of each thing corresponding to the trademark graph element code is segmented into one scorecard, and
i₂ indicates that the trademark image feature descriptors correspond to the trademark graph element codes, and the name of each thing corresponding to the trademark graph element codes is segmented into one scorecard; and
Y. a trademark scorecard standard consisting of multiple combination schemes of minimum units the elements of which are exceptional adjustment characters, comprising: at least one of scorecard standards y₁ and y₂, wherein:
y₁ indicates that the trademark contains the exceptional adjustment characters, and the overall exceptional adjustment characters are segmented into one scorecard, and
y₂ indicates that the trademark contains the exceptional adjustment characters, and each character of the overall exceptional adjustment characters is segmented into one scorecard respectively.
